(19) United States
(12) Patent Application Publication
(10) Pub. No.: US 2024/0412449 A1
(43) Pub. Date: Dec. 12, 2024

(54) VEHICLE DATA PROCESSING METHOD AND APPARATUS, ELECTRONIC DEVICE, AND STORAGE MEDIUM

(71) Applicant: TENCENT TECHNOLOGY (SHENZHEN) COMPANY LIMITED, Shenzhen (CN)

(72) Inventor: Yipeng ZHANG, Shenzhen (CN)

(21) Appl. No.: 18/808,047

(22) Filed: Aug. 18, 2024

Related U.S. Application Data
(63) Continuation of application No. PCT/CN2023/123462, filed on Oct. 9, 2023.

(30) Foreign Application Priority Data
Oct. 19, 2022 (CN) 202211284665.0

(51) Int. Cl. G06T 15/20; G05D 1/224; G06T 19/20; H04W 4/40

(52) U.S. Cl. CPC G06T 15/205; G05D 1/2245; G06T 19/20; H04W 4/40

(57) ABSTRACT

A vehicle data processing method includes: obtaining transmission duration for transmitting first driving data from a vehicle to a vehicle control terminal, the first driving data representing a driving condition of the vehicle at a first moment; calculating, based on the transmission duration and the first driving data, second driving data for representing a driving condition of the vehicle at a second moment, the second moment being later than the first moment; and generating, based on the second driving data, a driving image representing the driving condition of the vehicle at the second moment.

### CROSS-REFERENCES TO RELATED APPLICATIONS

This application is a continuation application of PCT Patent Application No. PCT/CN2023/123462, filed on Oct. 9, 2023, which claims priority to Chinese Patent Application No. 202211284665.0, filed with the China National Intellectual Property Administration on Oct. 19, 2022 and entitled “VEHICLE DRIVING CONTROL METHOD AND APPARATUS, DEVICE, AND MEDIUM”, the entire contents of both of which are incorporated herein by reference.

### FIELD OF THE TECHNOLOGY

The present disclosure relates to the field of communication technologies, and specifically, to a vehicle data processing method and apparatus, an electronic device, a storage medium, and a program product.

### BACKGROUND OF THE DISCLOSURE

During the operation of vehicle-to-everything services, a vehicle can interact with a remote control terminal over a network, so that the vehicle can travel safely and reliably on the road.

For example, the vehicle can send a corresponding driving image on a vehicle terminal to the remote control terminal, and then the remote control terminal can correspondingly control the vehicle based on the driving image, and the like. However, the driving image viewed on the remote control terminal is in a lagging state (e.g., due to network latency) which results in low accuracy in correspondingly controlling the vehicle based on the hysteretic driving image.

Therefore, how to improve accuracy of remote vehicle driving control is an urgent problem to be solved.

### SUMMARY

Embodiments of the present disclosure provide a vehicle data processing method and apparatus, an electronic device, a storage medium, and a program product, which help to improve accuracy of a driving image presented to a vehicle control terminal, thereby improving accuracy of vehicle driving control at least to a specific extent.

According to a first aspect, an embodiment of the present disclosure provides a vehicle data processing method. The method includes: obtaining transmission duration for transmitting first driving data from a vehicle to a vehicle control terminal, the first driving data representing a driving condition of the vehicle at a first moment; calculating, based on the transmission duration and the first driving data, second driving data for representing a driving condition of the vehicle at a second moment, the second moment being later than the first moment; and generating, based on the second driving data, a driving image representing the driving condition of the vehicle at the second moment.

According to a second aspect, an embodiment of the present disclosure provides a vehicle data processing apparatus. The apparatus includes: an obtaining module, configured to obtain transmission duration for transmitting first driving data from a vehicle to a vehicle control terminal, the first driving data representing a driving condition of the vehicle at a first moment; a calculation module, configured to calculate, based on the transmission duration and the first driving data, second driving data for representing a driving condition of the vehicle at a second moment, the second moment being later than the first moment; and a construction module, configured to generate, based on the second driving data, a driving image representing the driving condition of the vehicle at the second moment.

According to a third aspect, an embodiment of the present disclosure provides an electronic device, including one or more processors; and a memory, configured to store one or more programs, the one or more programs, when executed by the one or more processors, enabling the electronic device to implement the foregoing vehicle data processing method.

According to a fourth aspect, an embodiment of the present disclosure provides a non-transitory computer-readable storage medium, having a computer program stored thereon, the computer program, when executed by a processor, implementing the foregoing vehicle data processing method.

### BRIEF DESCRIPTION OF THE DRAWINGS

FIG. 1a to FIG. 1d are schematic diagrams of driving image hysteresis in related art.

FIG. 2 is a schematic diagram of an exemplary implementation environment in which the technical solutions of embodiments of the present disclosure can be applied.

FIG. 3 is a flowchart of a vehicle data processing method according to an exemplary embodiment of the present disclosure.

FIG. 4 is a flowchart of a vehicle data processing method according to another exemplary embodiment of the present disclosure.

FIG. 5 is a flowchart of a vehicle data processing method according to another exemplary embodiment of the present disclosure.

FIG. 6 is a flowchart of a vehicle data processing method according to another exemplary embodiment of the present disclosure.

FIG. 7 is a flowchart of a vehicle data processing method according to another exemplary embodiment of the present disclosure.

FIG. 8 is a schematic diagram of a vehicle traveling distance according to an exemplary embodiment of the present disclosure.

FIG. 9 is a schematic diagram of a vehicle traveling distance according to another exemplary embodiment of the present disclosure.

FIG. 10 is a flowchart of a vehicle data processing method according to another exemplary embodiment of the present disclosure.

FIG. 11 is a flowchart of a vehicle data processing method according to another exemplary embodiment of the present disclosure.

FIG. 12 is a flowchart of a vehicle data processing method according to another exemplary embodiment of the present disclosure.

FIG. 13 is a flowchart of a vehicle data processing method according to another exemplary embodiment of the present disclosure.

FIG. 14 is a flowchart of a vehicle data processing method according to another exemplary embodiment of the present disclosure.

FIG. 15 is a flowchart of a vehicle data processing method according to another exemplary embodiment of the present disclosure.

FIG. 16 is a flowchart of a vehicle data processing method according to another exemplary embodiment of the present disclosure.

FIG. 17 is a flowchart of a vehicle data processing method according to another exemplary embodiment of the present disclosure.

FIG. 18 is a schematic diagram of an exemplary implementation environment in which the technical solutions of embodiments of the present disclosure can be applied.

FIG. 19 is a block diagram of a remote driving car according to an exemplary embodiment of the present disclosure.

FIG. 20 is a flowchart of a vehicle data processing method according to an exemplary embodiment of the present disclosure.

FIG. 21a to FIG. 21d are schematic diagrams of driving images after delay compensation according to an exemplary embodiment of the present disclosure.

FIG. 22 is a schematic diagram of comparison of a driving image before and after delay compensation according to an exemplary embodiment of the present disclosure.

FIG. 23 is a block diagram of vehicle data processing apparatus according to an embodiment of the present disclosure.

FIG. 24 is a schematic diagram of a structure of a computer system suitable for implementing an electronic device according to an embodiment of the present disclosure.

### DESCRIPTION OF EMBODIMENTS

Exemplary embodiments are described in detail herein, and examples of the exemplary embodiments are shown in the accompanying drawings. When the following description involves the accompanying drawings, unless otherwise indicated, the same numerals in different accompanying drawings represent the same or similar elements. The implementations described in the following exemplary embodiments do not represent all implementations consistent with the present disclosure. Instead, the implementations are merely examples of apparatuses and methods that are described in detail in the appended claims and that are consistent with some aspects of the present disclosure.

The block diagrams shown in the accompanying drawings are merely functional entities and do not necessarily correspond to physically independent entities. In other words, the functional entities may be implemented in a software form, or in one or more hardware modules or integrated circuits, or in different networks and/ωr processor apparatuses and/ωr microcontroller apparatuses.

The flowcharts shown in the accompanying drawings are merely exemplary descriptions, do not need to include all content and operations, and do not need to be performed in the described orders either. For example, some operations may be further divided, while some operations may be combined or partially combined. Therefore, an actual execution order may change according to an actual case.

“Plurality of” mentioned in the present disclosure means two or more. The term “and/ωr” describes an association relationship between associated objects and indicates that three relationships may exist. For example, A and/ωr B may indicate the following three cases: Only A exists, both A and B exist, and only B exists. The character “/” generally indicates an “or” relationship between the associated objects.

In related art, a vehicle can send a corresponding driving image on a vehicle terminal to a vehicle control terminal (for example, a remote control terminal), and then the vehicle control terminal can correspondingly control the vehicle based on the driving image, and the like. However, the driving image viewed on the vehicle control terminal is in a hysteretic state (for example, a driving image viewed on the vehicle control terminal at moment T1 corresponds to a driving image at moment T0, where moment T1 is later than moment T0), which results in low accuracy in controlling the vehicle based on the hysteretic driving image.

In related art, the vehicle can send a corresponding driving image on a vehicle terminal to the vehicle control terminal, and then the vehicle control terminal can correspondingly control the vehicle based on the driving image, and the like. However, the driving image viewed on the vehicle control terminal is in a hysteretic state, which results in low accuracy in correspondingly controlling the vehicle based on the hysteretic driving image.

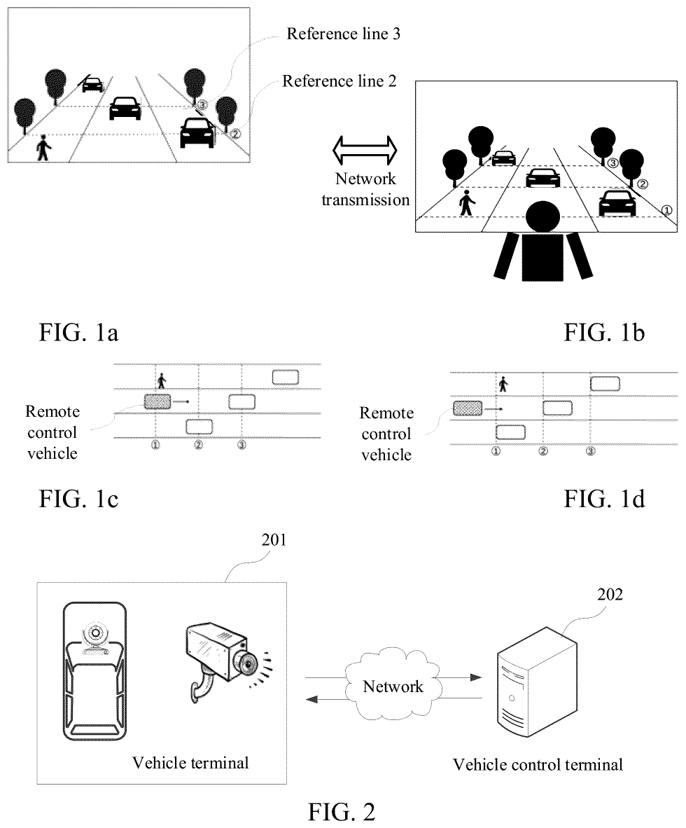

For ease of understanding, FIG. 1a to FIG. 1c show actual driving conditions of a vehicle. FIG. 1a is a perspective of a vehicle camera, and FIG. 1c shows actual relative distances between vehicles. FIG. 1b to FIG. 1d are driving conditions of the vehicle viewed on the vehicle control terminal. FIG. 1b is a perspective of a driver at the vehicle control terminal, and FIG. 1d shows relative distances between vehicles as viewed by the driver at the vehicle control terminal.

Since it takes a specific amount of duration for driving data to be transmitted over a network, the driving image viewed on the vehicle control terminal is actually an actual driving condition of the vehicle in the past. As shown in FIG. 1a and FIG. 1b, the actual condition of the vehicle is that the vehicle has moved forward a specific distance, but the driver at the vehicle control terminal sees that the vehicle is still a specific distance away from a reference line 1. However, in fact, the vehicle has passed the reference line 1 and is very close to the pedestrian, posing a risk of collision, as shown in FIG. 1c and FIG. 1d. Assuming that the vehicle is traveling at speed of 60 km/h, transmission duration of the driving data is 200 ms, and an actual position of the vehicle moves: D=v*t=60/3.6*0.2=3.33 m relative to the distance viewed by the driver at the vehicle control terminal. In this case, the driver at the vehicle control terminal is prone to make wrong control. It can be learned that due to the hysteresis of the driving image, the driving image displayed at the display moment does not match the actual driving condition at the current display moment (that is, the driving image is inaccurate), which reduces accuracy of vehicle driving control.

Therefore, to improve accuracy of the driving image, the present disclosure provides a vehicle data processing method. FIG. 2 is a schematic diagram of an implementation environment according to the present disclosure. The implementation environment mainly includes a vehicle terminal 201 and a vehicle control terminal 202. The vehicle terminal 201 is communicatively connected to the vehicle control terminal 202 over a network. The network may include various connection types, such as wired, wireless communication links, or fiber optic cables.

The vehicle terminal 201 may be any vehicle having an on-board terminal and/ωr a collection device.

In one embodiment, the vehicle terminal may be hardware or software. If the on-board terminal is hardware, the on-board terminal may be various electronic devices, including but not limited to a mobile phone, a tablet computer, a laptop, a computer, a smart voice interaction device, a smart home appliance, a smart wearable device, an aerial vehicle, or the like. If the on-board terminal is software, the on-board terminal can be installed in the electronic devices listed above.

In one embodiment, the collection device may include any camera, or the like, and the acquisition device is configured to collect a video stream including a driving image.

In one embodiment, the vehicle includes, but is not limited to, a cargo vehicle, a dump truck, an off-road vehicle, a car, a bus, a tracωr vehicle and a semi-trailer tracωr vehicle, a special vehicle, and the like. The cargo vehicle is mainly configured to transport goods, and some cargo vehicles can also tow a full trailer. The dump truck is a vehicle that is mainly used to transport goods and equipped with a mechanism (e.g., an open-box bed with hydraulic ram for lifting the front) to deposit the goods. The dump truck is mainly suitable for driving on bad roads or in areas without roads, and mostly used in forest areas and mines. The off-road vehicle (e.g., sport utility vehicle (SUV)) is an all-wheel drive vehicle with high passability (e.g., raised ground clearance), mainly used in bad roads or areas without roads. The off-road vehicle is suitable for driving on bad roads or areas without roads, and mostly used in forest areas and mines. The car is a four-wheel vehicle configured to carry people and belongings and having seats arranged between two axles. According to engine displacement, the car can be divided into a micro vehicle (less than 1 L), an ordinary car (1 L to 1.6 L), an intermediate car (1.6 L to 2.5 L), a middle and senior car (2.5 L to 4 L), a senior car (4 L or more). The bus is a vehicle having rectangular compartments, and is mainly configured for carrying people and belongings. According to different uses, the bus can be divided into a long-distance bus, a group bus, a city public vehicle, a tourist bus, and the like. The tracωr vehicle and semi-trailer tracωr vehicle are mainly configured for towing trailers or semi-trailers. According to different tractor-trailers, the tracωr vehicle can be divided into a semi-trailer and a full tractor-trailer. The special vehicle is equipped with a special device and has special functions, and is configured for undertaking special transportation tasks or special operations, such as a fire truck, an ambulance, an oil tanker, a bullet-proof vehicle, an engineering vehicle, and the like.

The vehicle control terminal 202 is, for example, a terminal that remotely controls the vehicle.

In one embodiment, the vehicle control terminal may be a mobile phone, a tablet computer, a laptop, a computer, a smart voice interaction device, a smart home appliance, a smart wearable device, an aerial vehicle, and the like.

In one embodiment, the vehicle control terminal may be a server that provides various services. The server may be an independent physical server, or a server cluster or distributed system including a plurality of physical servers, or a cloud server providing a cloud service, a cloud database, cloud computing, a cloud function, cloud storage, a network service, cloud communication, a middleware service, a domain name service, a security service, a content delivery network (CDN), a big data and artificial intelligence platform, or the like. This is not limited herein.

A quantity of vehicles corresponding to the vehicle terminal 201 and a quantity of servers corresponding to the vehicle control terminal 202 in FIG. 2 are only schematic. There may be any quantity of vehicles and servers according to actual needs.

In an embodiment of the present disclosure, the vehicle data processing method may be performed by the vehicle terminal 201.

For example, the vehicle terminal 201 may collect first driving data and send the first driving data to the vehicle control terminal 202.

In an embodiment of the present disclosure, the vehicle data processing method may be performed by the vehicle control terminal 202.

For example, the vehicle control terminal 202 receives the first driving data sent by the vehicle terminal 201 and obtains transmission duration required for the first driving data of the vehicle to be transmitted in a network. The first driving data is configured for representing a driving condition of the vehicle at a first moment. Then second driving data configured for representing a driving condition of the vehicle at a second moment is calculated. The second moment is later than the first moment. Next, a driving image representing the driving condition of the vehicle at the second moment is generated based on the second driving data. After that, the driving image is presented, so that the vehicle control terminal 202 can control a driving status of the vehicle based on the driving image.

The technical solutions of the embodiment shown in FIG. 2 can be applied to various scenarios, including but not limited to smart transportation, assisted driving, cloud technology, artificial intelligence, and the like. In actual application, adjustments can be correspondingly made according to specific application scenarios.

For example, if the technical solutions are applied to smart transportation or assisted driving scenarios, a vehicle-mounted terminal, a navigation terminal, and the like is installed in the vehicle terminal 201. For example, the vehicle-mounted terminal collects the first driving data and sends the first driving data to the vehicle control terminal.

For example, if the technical solutions are applied to the cloud technology or artificial intelligence scenarios, the vehicle control terminal 202 corresponds to a cloud server or the like. For example, the cloud server receives the first driving data sent by the vehicle and obtains transmission duration required for the first driving data of the vehicle to be transmitted in a network. The first driving data is configured for representing a driving condition of the vehicle at a first moment. Then, the driving condition of the vehicle at a second moment is calculated based on the transmission duration and the first driving data, to obtain second driving data. The second moment is later than the first moment. Next, a driving image representing the driving condition of the vehicle at the second moment is generated based on the second driving data. After that, the driving image is presented, so that a driving status of the vehicle is controlled based on the driving image.

In the specific implementations of the present disclosure, data related to users is involved. In a case that embodiments of the present disclosure are applied to a specific product or technology, permission or consent of a user is required, and collection, use, and processing of the relevant data need to comply with relevant laws, regulations, and standards of relevant countries and regions.

The various implementation details of the technical solutions of embodiments of the present disclosure are described in detail in the following.

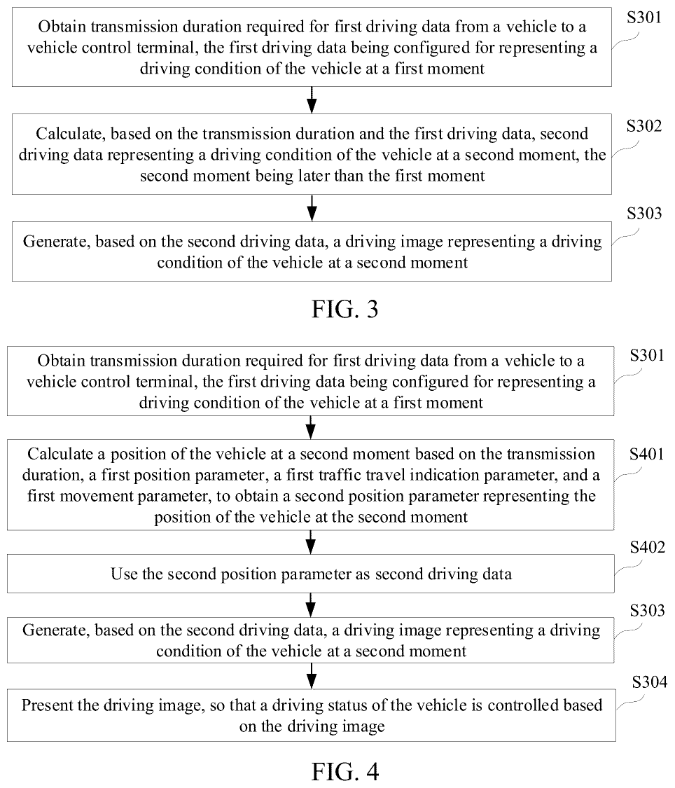

FIG. 3 is a flowchart of a vehicle data processing method according to an embodiment of the present disclosure. The vehicle data processing method may be performed by an electronic device such as the vehicle control terminal 202. As shown in FIG. 3, the vehicle data processing method includes at least S301 to S304, and details are as follows:

S301: Obtain transmission duration for transmitting first driving data from a vehicle to a vehicle control terminal, the first driving data representing a driving condition of the vehicle at a first moment.

The transmission duration in this embodiment of the present disclosure is duration for transmitting the first driving data of the vehicle to the vehicle control terminal over the network.

In an embodiment of the present disclosure, the first driving data may be collected by the vehicle and then transmitted to the vehicle control terminal over the network. For example, after vehicle 1 collects the first driving data, the vehicle control terminal starts sending driving data over the network at moment t1′, and the vehicle control terminal receives the driving data sent by vehicle 1 at moment t2′. At this time, the transmission duration is: T0′=t2′−t1′.

In an embodiment of the present disclosure, the vehicle may collect the first driving data and then transmit the first driving data to an intermediate device over the network (when the intermediate device obtains the first driving data, processing from S301 to S304 may be performed), and then the intermediate device may transmit the first driving data to the vehicle control terminal over the network. For example, after vehicle 1 collects the first driving data, the vehicle starts transmitting the first driving data to the intermediate device over the network at moment t1′. The intermediate device receives the first driving data sent by the vehicle 1 at moment t2′. At the same time, the intermediate device transmits the first driving data to the vehicle control terminal over the network at moment t2′. The vehicle control terminal receives the first driving data sent by the intermediate device at moment t3′. At this time, the transmission duration is: T0′=t3′−t1′.

In this embodiment of the present disclosure, the first driving data is driving data related to the driving condition of the vehicle at the first moment. In other words, the first driving data is configured for representing the driving condition of the vehicle at the first moment. The first driving data includes, but is not limited to, information about the vehicle, information about mobile objects (also referred to as dynamic objects) around the vehicle, and information about static objects around the vehicle.

The information about the vehicle includes, but is not limited to, position information, movement information, and the like. The position information may be obtained through positioning, for example, through a global positioning system (GPS), a global navigation satellite system (GNSS), and the like. The movement information may be at least one of speed, lateral acceleration, longitudinal acceleration, a yaw angular velocity, a steering angle, a heading angle, or the like. The lateral acceleration, longitudinal acceleration, yaw angular velocity, and steering angle can be obtained through a controller area network (CAN) bus, and the speed and heading angle can be obtained through a GNSS.

The mobile object is a mobile target around the vehicle, that is, relative to the vehicle, another mobile object other than the vehicle, such as a vehicle, a pedestrian, and an animal. The mobile object and the vehicle are in the same driving environment, or the mobile object is in the driving environment at which the vehicle is located. The driving environment may be considered, for example, as a driving scene perceived by a collection device that is in the vehicle and is configured to obtain the first driving data. Information about the mobile object also includes, but is not limited to, position information, movement information, and the like. The position information can be obtained through positioning, such as GPS, GNSS. The movement information may be at least one of speed, lateral acceleration, longitudinal acceleration, a yaw angular velocity, a steering angle, a heading angle, or the like. The lateral acceleration, longitudinal acceleration, yaw angular velocity, and steering angle can be obtained through the CAN bus, and the speed and heading angle can be obtained through the GNSS.

The static object is an object that cannot move in the driving environment at which the vehicle is located, such as lanes, roadsides, and traffic signs. Information about the static object includes, but is not limited to, lane information (such as a left turn lane, a straight lane, a right turn lane), roadside information (such as a roadside plant, a railing), traffic sign information (such as a traffic light, a traffic sign, a weather condition light), and the like.

S302: Calculate, based on the transmission duration and the first driving data, second driving data configured for representing a driving condition of the vehicle at a second moment. The second moment is later than the first moment.

In this embodiment of the present disclosure, the vehicle control terminal obtains the transmission duration required for the first driving data of the vehicle to be transmitted in the network, and then can calculate the driving condition of the vehicle at the second moment based on the transmission duration and the first driving data, to obtain the second driving data. In other words, in this embodiment of the present disclosure, the vehicle control terminal calculates, based on the transmission duration and the first driving data configured for representing the driving condition of the vehicle at the first moment, the second driving data configured for representing the driving condition of the vehicle at the second moment.

In this embodiment of the present disclosure, the second driving data is driving data related to the driving condition of the vehicle at the second moment. In other words, the second driving data is configured for representing the driving condition of the vehicle at the second moment. The second driving data includes, but is not limited to, information about the vehicle, information about another mobile object, and information about a static object. For details, reference may be made to the foregoing introductions. This is not described again herein.

In this embodiment of the present disclosure, the second moment is later than the first moment, and is related to the first moment and the transmission duration. The second moment may be a corresponding moment after the transmission duration from the first moment. For example, if the first moment is T1 and the transmission duration is T0′, then the second moment T2=T1+T0′.

S303: Generate, based on the second driving data, a driving image representing the driving condition of the vehicle at the second moment.

In this embodiment of the present disclosure, the vehicle control terminal calculates the driving condition of the vehicle at the second moment based on the transmission duration and driving data to obtain the second driving data. Then, the driving image of the vehicle at the second moment can be constructed based on the second driving data to obtain the driving image. In other words, the second driving data obtained in this embodiment of the present disclosure is configured for constructing the driving image of the vehicle at the second moment, to obtain the driving image of the vehicle at the second moment.

In conclusion, according to the solution of the embodiment of the present disclosure, the first driving data corresponding to the first moment is used to calculate the second driving data corresponding to the second moment, to generate the corresponding driving image, so that the driving image at one display moment (that is, the second moment) is more consistent with an actual driving condition at the current display moment, thereby avoiding inaccuracy of the driving image caused by the transmission duration, improving accuracy of the displayed driving image, facilitating improvement of accuracy of vehicle driving control, improving vehicle driving safety, and ensuring road traffic safety.

In some embodiments, the vehicle data processing method may also include operation S304.

S304: Present the driving image, so that a driving status of the vehicle is controlled based on the driving image.

In this embodiment of the present disclosure, the vehicle control terminal constructs the driving image of the vehicle at the second moment based on the second driving data to obtain the driving image, and then the driving image can be presented at the second moment, so that a driver at the vehicle control terminal can control, at the second moment, the driving status of the vehicle based on the driving image.

In an embodiment of the present disclosure, the vehicle is a remote driving vehicle. The process of presenting the driving image in S304 may include: The driving image is remotely displayed on the vehicle control terminal, so that the driver at the vehicle control terminal controls the driving status of the remote driving vehicle based on the driving image displayed on a remote control device.

The degree of automation of a vehicle can be divided into manual driving, driving assistance, partial automation, conditional automation, high automation, and complete automation, which respectively correspond to six levels L₀ to L₅ of driving, driving assistance, partial automation, conditional automation, high automation, and complete automation. During driving processes of vehicles having the three driving levels L₀ to L₂, drivers still play a dominant role in vehicle control, and the vehicles only function to assist the drivers with operations. A vehicle having the driving level of L₃ has an ability to make independent determining and decisions. When a specific condition is satisfied, the vehicle can perform automatic driving, but the driver is required to pay attention to the driving condition all the time and be able to take over the vehicle at any time when necessary, to complete the driving task. Vehicles having the two levels L₄ to L₅ control all aspects of driving experience and do not expect drivers to intervene during a normal driving task.

Therefore, the solution in embodiments of the present disclosure may be applied to any scenario in which drivers are needed (for example, the driving levels of L₁ to L₃), thereby improving accuracy of vehicle driving control.

In an embodiment of the present disclosure, another vehicle data processing method is provided. The vehicle data processing method may be performed by the vehicle control terminal 202 as a control party. As shown in FIG. 4, the vehicle data processing method may include S401 and S402, S301 as well as S303 and S304.

In this embodiment of the present disclosure, the first driving data includes, but is not limited to, a first position parameter indicating a position of the vehicle at the first moment, a first traffic travel indication parameter indicating a traveling direction of the vehicle, and a first movement parameter indicating a motion state of the vehicle.

For example, the first position parameter refers to information related to a geographical position of the vehicle at the first moment, which may be the position information described in the foregoing embodiments.

The first traffic travel indication parameter refers to vehicle traveling information or information based on which the vehicle is to travel at the first moment, which may be the heading angle described in the foregoing embodiments (which is also a movement parameter). In addition, the first traffic travel indication parameter may further include lane information and traffic sign information.

The first movement parameter refers to information related to the movement of the vehicle at the first moment, which can be the speed, angular velocity, and the like described in the foregoing embodiments.

S401 and S402 are described in detail as follows:

S401: Calculate a position of the vehicle at the second moment based on the transmission duration, the first position parameter, the first traffic travel indication parameter, and the first movement parameter, to obtain a second position parameter representing the position of the vehicle at the second moment.

In this embodiment of the present disclosure, the vehicle control terminal may calculate the position of the vehicle at the second moment based on the transmission duration, the first position parameter, the first traffic travel indication parameter, and the first movement parameter, to obtain the second position parameter. In other words, in this embodiment of the present disclosure, the position of the vehicle at the second moment is calculated based on the four factors of transmission duration, first position parameter, first traffic travel indication parameter, and first movement parameter, to obtain the second position parameter.

S402: Use the second position parameter as second driving data.

In this embodiment of the present disclosure, the vehicle control terminal calculates a position parameter of the vehicle at the second moment based on the transmission duration, the first position parameter, the first traffic travel indication parameter, and the first movement parameter, and the obtained second position parameter can be used as the second driving data.

In this embodiment of the present disclosure, the second position parameter refers to information related to the geographical position of the vehicle at the second moment. A main difference between the second position parameter and the first position parameter is that the second position parameter corresponds to the second moment, and the first position parameter corresponds to the first moment.

For the detailed descriptions to S301 as well as S303 and S304 shown in FIG. 4, reference may be made to S301 as well as S303 and S304 shown in FIG. 3. This is not described again herein.

In this embodiment of the present disclosure, the vehicle control terminal calculates the position parameter of the vehicle at the second moment based on the first position parameter, the first traffic travel indication parameter, and the first movement parameter of the vehicle at the first moment, and can quickly and easily obtain the second driving data, thereby improving a rate of subsequently constructing a driving image of the vehicle at the second moment based on the second driving data.

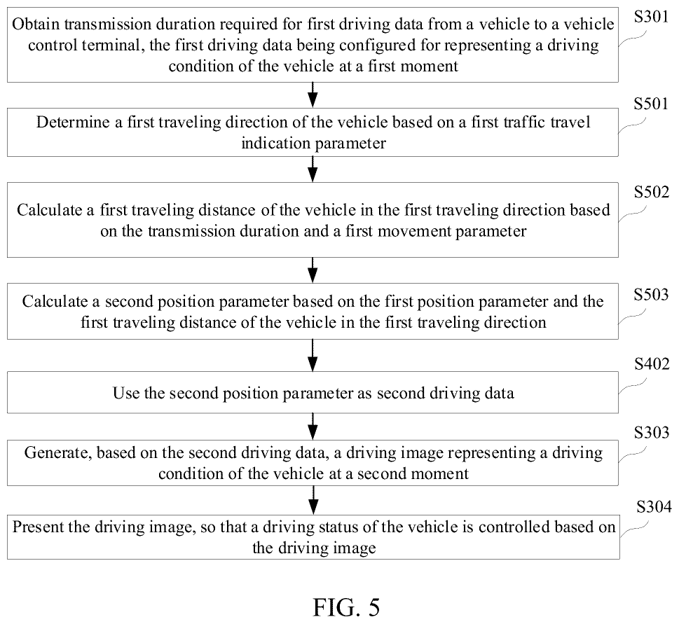

In an embodiment of the present disclosure, another vehicle data processing method is provided. The vehicle data processing method may be performed by the vehicle control terminal 202 as a control party. As shown in FIG. 5, the vehicle data processing method may include S501 to S503, S402, S301 as well as S303 and S304.

S501 and S503 are described in detail as follows:

S501: Determine a first traveling direction of the vehicle based on the first traffic travel indication parameter.

In this embodiment of the present disclosure, the vehicle control terminal may determine the first traveling direction of the vehicle based on the first traffic travel indication parameter.

In this embodiment of the present disclosure, the first traveling direction refers to a traveling direction of the vehicle at the first moment. The traveling may be forward (for example, going straight or turning) or backward (for example, reversing).

S502: Calculate, based on the transmission duration and the first movement parameter, a first traveling distance of the vehicle in the first traveling direction.

In this embodiment of the present disclosure, the vehicle control terminal determines the first traveling direction of the vehicle based on the first traffic travel indication parameter, and then calculates the first traveling distance of the vehicle in the first traveling direction based on the transmission duration and the first movement parameter.

In this embodiment of the present disclosure, the first traveling distance is a traveling distance that the vehicle moves in the first traveling direction at the first moment. For example, if the traveling direction is a straight direction, a traveling distance that the vehicle moves in the straight direction at the first moment is calculated; or if the traveling direction is a turning direction, a traveling distance that the vehicle moves in the turning direction at the second moment is calculated.

S503: Calculate the second position parameter based on the first position parameter and the first traveling distance of the vehicle in the first traveling direction.

In this embodiment of the present disclosure, the vehicle control terminal calculates the first traveling distance of the vehicle in the first traveling direction based on the transmission duration and the first movement parameter, and then can calculate the second position parameter based on the first position parameter and the first traveling distance of the vehicle in the first traveling direction. In other words, in this embodiment of the present disclosure, the position parameter of the vehicle at the second moment is calculated based on the position parameter of the vehicle at the first moment and a traveling distance that the vehicle moves in a traveling direction within the transmission duration.

For the detailed descriptions to S402 shown in FIG. 5, reference may be made to S402 shown in FIG. 4. For the detailed descriptions to S301 as well as S303 and S304 shown in FIG. 5, reference may be made to S301 as well as S303 and S304 shown in FIG. 3. This is not described again herein.

In this embodiment of the present disclosure, the vehicle control terminal can quickly and easily obtain the position parameter of the vehicle at the second moment based on the position parameter of the vehicle at the first moment and the traveling distance that the vehicle moves in the traveling direction within the transmission duration, thereby providing support for subsequent construction of a driving image of the vehicle at the second moment.

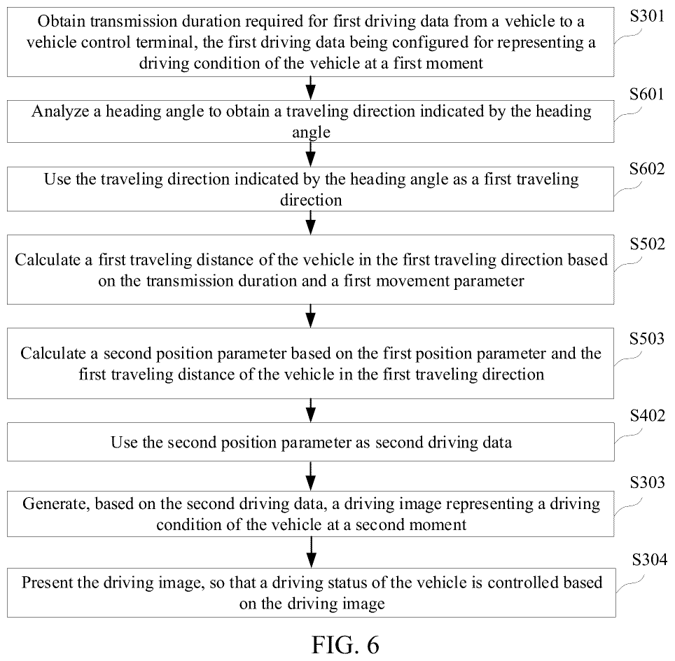

In an embodiment of the present disclosure, another vehicle data processing method is provided. The vehicle data processing method may be performed by the vehicle control terminal 202 as a control party. As shown in FIG. 6, the vehicle data processing method may include S601 and S602, S502 and S503, S402, S301 as well as S303 and S304.

In this embodiment of the present disclosure, the first traffic travel indication parameter includes a heading angle. For example, the first traveling direction can be analyzed based on the heading angle.

S601 and S602 are described in detail as follows:

S601: Analyze the heading angle to obtain a traveling direction indicated by the heading angle.

In this embodiment of the present disclosure, the vehicle control terminal can analyze the heading angle, thereby obtaining the traveling direction indicated by the heading angle.

S602. Use the traveling direction indicated by the heading angle as the first traveling direction.

In this embodiment of the present disclosure, the vehicle control terminal analyzes the heading angle, and the obtained traveling direction indicated by the heading angle is used as the first traveling direction.

In an embodiment of the present disclosure, the first traffic travel indication parameter includes lane information and traffic sign information. In S501, the determining a first traveling direction of the vehicle based on the first traffic travel indication parameter may include: detecting matching of a traveling direction indicated by the lane information and a traveling direction indicated by the traffic sign information, to obtain a detection result; and using, if the detection result indicates that the traveling direction indicated by the lane information matches the traveling direction indicated by the traffic sign information, the traveling direction indicated by the lane information or the traveling direction indicated by the traffic sign information as the first traveling direction.

In other words, in an exemplary embodiment, the vehicle control terminal can detect the matching between the traveling direction indicated by the lane information and the traveling direction indicated by the traffic sign information, to obtain a detection result, and then determine the first traveling direction of the vehicle based on the detection result.

If the lane information is a left-turn lane, an indicated traveling direction is a left-turn direction. If the lane information is a straight lane, an indicated traveling direction is a straight direction. If the lane information is a right-turn lane, an indicated traveling direction is a right-turn direction.

If the traffic sign information is a traffic light, the traffic sign information indicates a green traveling direction. If the traffic sign information is a traffic signpost, a traveling direction indicated by the traffic sign information is a specific traveling direction indicated by the traffic signpost.

In an exemplary embodiment, the vehicle control terminal determines the first traveling direction of the vehicle based on the detection result, including at least the following two cases:

Case 1: Use, if the detection result indicates that the traveling direction indicated by the lane information matches the traveling direction indicated by the traffic sign information, the traveling direction indicated by the lane information or the traveling direction indicated by the traffic sign information as the first traveling direction.

For example, assuming that the lane information is a straight lane, the indicated traveling direction is the straight direction, and in addition, assuming that the traveling direction indicated by the traffic sign information is the straight direction, the detection result obtained in this case is configured for representing that the traveling direction indicated by the lane information matches the traveling direction indicated by the traffic sign information, and then the straight direction is used as the first traveling direction.

Case 2: Determine, if the detection result indicates that the traveling direction indicated by the lane information does not match the traveling direction indicated by the traffic sign information, the first traveling direction based on a historical trajectory of the vehicle.

In an exemplary embodiment, the historical trajectory of the vehicle is a driving trajectory of the vehicle before the current moment. In one embodiment, the historical trajectory of the vehicle may be a most common driving trajectory for a user, may be all driving trajectories before the current moment, or the like.

In an exemplary embodiment, the determining the first traveling direction based on the historical trajectory of the vehicle may be to obtain a traveling direction corresponding to a position in the historical trajectory of the vehicle that matches the first position parameter of the vehicle at the first moment, and use the obtained traveling direction as the first traveling direction.

For example, assuming that the lane information is a straight lane, the indicated traveling direction is the straight direction, and in addition, assuming that the traveling direction indicated by the traffic sign information is the left-turn direction, the detection result obtained in this case is configured for representing that the traveling direction indicated by the lane information does not match the traveling direction indicated by the traffic sign information, and then the historical trajectory of the vehicle is obtained to determine the first traveling direction based on the historical trajectory of the vehicle.

For the detailed descriptions to S502 and S503 shown in FIG. 6, reference may be made to S502 and S503 shown in FIG. 5, for the detailed descriptions to S402 shown in FIG. 6, reference may be made to S402 shown in FIG. 4, and for the detailed descriptions to S301 as well as S303 and S304 shown in FIG. 6, reference may be made to S301 as well as S303 and S304 shown in FIG. 3. This is not described again herein.

In this embodiment of the present disclosure, the vehicle control terminal can quickly and easily determine the first traveling direction of the vehicle through an analysis of the heading angle, and since the heading angle is obtained by collecting, the heading angle can represent an actual driving condition of the vehicle. Therefore, the first traveling direction of the vehicle determined based on the heading angle is more accurate and suitable for many application scenarios.

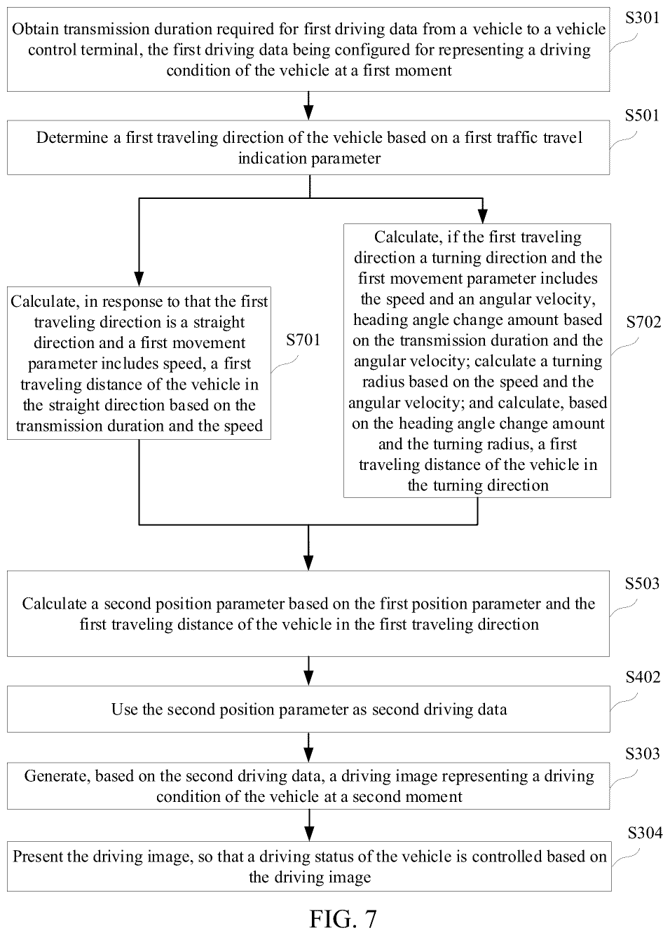

In an embodiment of the present disclosure, another vehicle data processing method is provided. The vehicle data processing method may be performed by the vehicle control terminal 202 as a control party. As shown in FIG. 7, the vehicle data processing method may include S701 and S702, S501, S503, S402, S301 as well as S303 and S304.

S701 and S702 are described in detail as follows:

S701: Calculate, in response to that the first traveling direction is a straight direction and the first movement parameter includes speed, a first traveling distance of the vehicle in the straight direction based on the transmission duration and the speed.

In this embodiment of the present disclosure, if the first traveling direction is the straight direction and the first movement parameter includes the speed, the first traveling distance of the vehicle in the straight direction is calculated based on the transmission duration and the speed.

In an embodiment of the present disclosure, in S701, the calculating a first traveling distance of the vehicle in the straight direction based on the transmission duration and the speed may include: multiplying the transmission duration and the speed to obtain the first traveling distance of the vehicle in the straight direction.

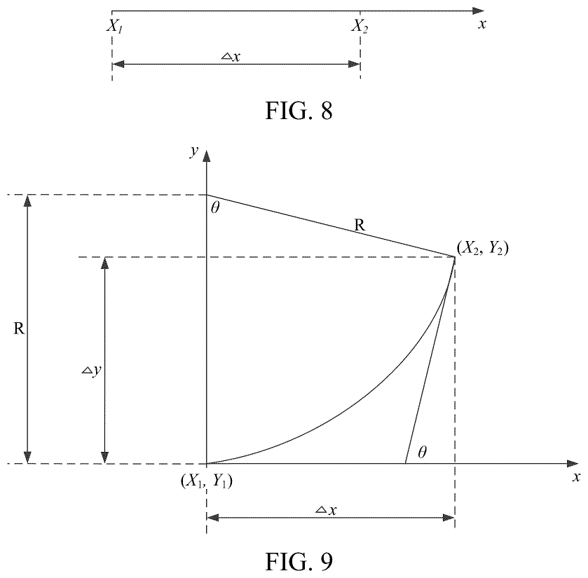

For example, refer to FIG. 8. A position coordinate of the vehicle at the first moment is X₁, and a position coordinate of the vehicle at the second moment is X₂. Assuming the transmission duration is Δt and the speed is v, then the first traveling distance of the vehicle in the straight direction is: Δx=Δt*v. Vertical coordinates in the straight direction are all zero.

S702: Calculate, in response to that the first traveling direction is a turning direction and the first movement parameter includes speed and an angular velocity, heading angle change amount based on the transmission duration and the angular velocity; calculate a turning radius based on the speed and the angular velocity; and calculate, based on the heading angle change amount and the turning radius, a first traveling distance of the vehicle in the turning direction.

In this embodiment of the present disclosure, if the first traveling direction is the turning direction and the first movement parameter includes the speed and the angular velocity, the heading angle change amount is calculated based on the transmission duration and the angular velocity; the turning radius is calculated based on the speed and the angular velocity; and the first traveling distance of the vehicle in the turning direction is calculated based on the heading angle change amount and the turning radius.

In an embodiment of the present disclosure, in S702, the calculating heading angle change amount based on the transmission duration and the angular velocity may include: multiplying the transmission duration and the angular velocity to obtain the heading angle change amount.

In an embodiment of the present disclosure, in S702, the calculating a turning radius based on the speed and the angular velocity may include: taking a quotient of the speed and the angular velocity to obtain the turning radius.

In an embodiment of the present disclosure, in S702, the calculating, based on the heading angle change amount and the turning radius, a first traveling distance of the vehicle in the turning direction may include two cases (since there is a turn, horizontal and vertical coordinates all correspond to traveling distances): Case 1: For the horizontal coordinate, calculate a sine value of the heading angle change amount, multiply the sine value of the heading angle change amount by the turning radius, to obtain a traveling distance on the horizontal coordinate. Case 2: For the vertical coordinate, calculate a cosine value of the heading angle change amount, multiply the cosine value of the heading angle change amount by the turning radius, and then subtract the product from turning radius to obtain a traveling distance on the vertical coordinate.

For example, refer to FIG. 9. Position coordinates of the vehicle at the first moment are (X₁, Y₁), and position coordinates of the vehicle at the second moment are (X₂, Y₂). Assuming that the transmission duration is Δt, the speed is v, and the angular velocity is ωᵣ, then the heading angle change amount is: θ=Δt·ωᵣ, the turning radius R is: =v/ωᵣ, the traveling distance of the vehicle on the horizontal coordinate is: Δx=R sin θ=v/ωᵣ·sin(ωᵣ·Δt), and the traveling distance of the vehicle on the vertical coordinate is: Δy=R−R cos θ=R(1−cos θ)=v/ωᵣ·(1−cos(ωᵣ·Δt)).

For the detailed descriptions to S501 and S503 shown in FIG. 7, reference may be made to S501 and S503 shown in FIG. 5, for the detailed descriptions to S402 shown in FIG. 7, reference may be made to S402 shown in FIG. 4, and for the detailed descriptions to S301 as well as S303 and S304 shown in FIG. 7, reference may be made to S301 as well as S303 and S304 shown in FIG. 3. This is not described again herein.

In this embodiment of the present disclosure, the vehicle control terminal performs corresponding processing for different traveling directions (that is, the straight direction and turning direction), to obtain a more accurate first traveling distance, thereby improving accuracy of subsequent calculation of a position parameter of the vehicle at the second moment.

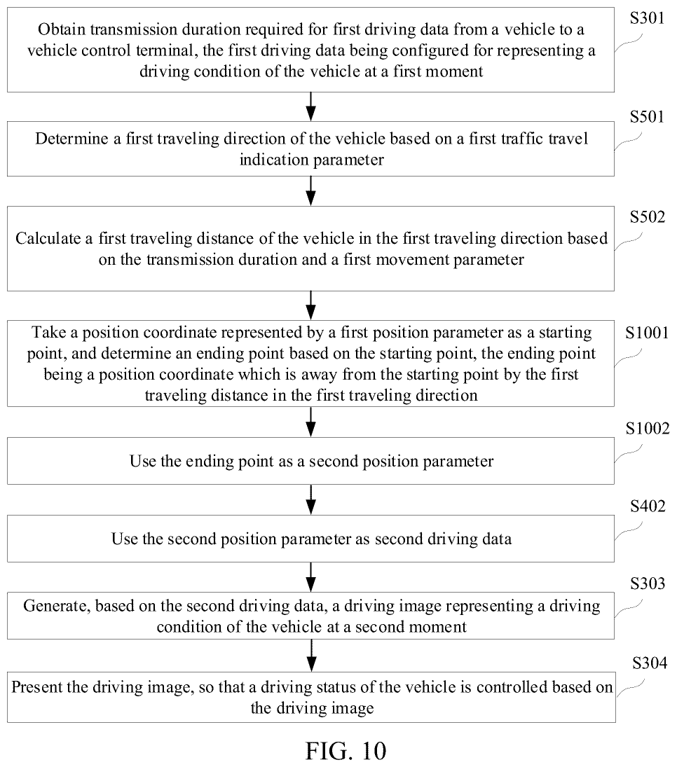

In an embodiment of the present disclosure, another vehicle data processing method is provided. The vehicle data processing method may be performed by the vehicle control terminal 202 as a control party. As shown in FIG. 10, the vehicle data processing method may include S1001 and S1002, S501 and S502, S402, S301 as well as S303 and S304.

In an embodiment, a position coordinate represented by the first position parameter is taken as a starting point, and a position coordinate which is away from the starting point by the first traveling distance in the first traveling direction is determined as the second position parameter.

S1001 and S1002 are described in detail as follows:

S1001: Take the position coordinate represented by the first position parameter as the starting point, and determine an ending point based on the starting point. The ending point is a position coordinate which is away from the starting point by the first traveling distance in the first traveling direction.

In this embodiment of the present disclosure, the vehicle control terminal may take the position coordinate represented by the first position parameter as the starting point, and determine the ending point based on the starting point. The ending point is a position coordinate which is away from the starting point by the first traveling distance in the first traveling direction.

For example, following the example of FIG. 8, X₁ is the starting point, and the determined ending point is X₁+Δx. X₁+Δx is X₂.

For another example, following the example of FIG. 9, (X₁, Y₁) is the starting point, and the determined ending point is (X₁+Δx, Y₁+Δy). (X₁+Δx, Y₁+Δy) is (X₂, Y₂).

S1002: Use the ending point as the second position parameter.

In this embodiment of the present disclosure, the vehicle control terminal takes the position coordinate represented by the first position parameter as the starting point, and uses the ending point determined based on the starting point as the second position parameter.

For the detailed descriptions to S501 and S502 shown in FIG. 10, reference may be made to S501 and S502 shown in FIG. 5, for the detailed descriptions to S402 shown in FIG. 10, reference may be made to S402 shown in FIG. 4, and for the detailed descriptions to S301 as well as S303 and S304 shown in FIG. 10, reference may be made to S301 as well as S303 and S304 shown in FIG. 3. This is not described again herein.

In this embodiment of the present disclosure, the vehicle control terminal can quickly and easily determine the second position parameter of the vehicle by taking the position coordinate represented by the first position parameter as the starting point and determining the ending point based on the starting point, which is suitable for many application scenarios.

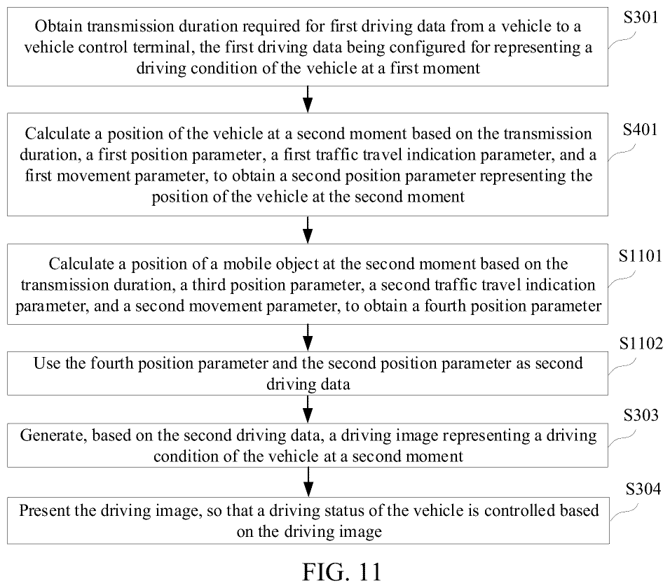

In an embodiment of the present disclosure, another vehicle data processing method is provided. The vehicle data processing method may be performed by the vehicle control terminal 202 as a control party. As shown in FIG. 11, the vehicle data processing method may include S1101 to S1102, S401, S301 as well as S303 and S304.

In this embodiment of the present disclosure, the first driving data further includes an environmental parameter of the vehicle at the first moment, the environmental parameter includes a third position parameter for indicating a position of a mobile object around the vehicle at the first moment, a second traffic travel indication parameter indicating a traveling direction of the mobile object, and a second movement parameter indicating a motion state of the mobile object.

The third position parameter refers to information related to a geographical position of the mobile object at the first moment, which may be the position information described in the foregoing embodiments.

The second traffic travel indication parameter refers to mobile object traveling information or information based on which the mobile object is to travel or may travel at the first moment, which may be the lane information and traffic sign information described in the foregoing embodiments.

The second movement parameter refers to information related to the movement of the mobile object at the first moment, which may be the speed, heading angle, and the like described in the foregoing embodiments.

S1101 and S1102 are described in detail as follows:

S1101: Calculate a position parameter of the mobile object at the second moment based on the transmission duration, the third position parameter, the second traffic travel indication parameter, and the second movement parameter, to obtain a fourth position parameter.

In this embodiment of the present disclosure, the vehicle control terminal can calculate the position parameter of the mobile object at the second moment is calculated based on the transmission duration, the third position parameter, the second traffic travel indication parameter, and the second movement parameter, to obtain the fourth position parameter. In other words, in this embodiment of the present disclosure, the position parameter of the mobile object at the second moment is calculated by using the four factors of the transmission duration, the third position parameter, the second traffic travel indication parameter, and the second movement parameter, to obtain the fourth position parameter.

S1102: Use the fourth position parameter and the second position parameter as the second driving data.

In this embodiment of the present disclosure, the vehicle control terminal calculates the position parameter of the mobile object at the second moment based on the transmission duration, the third position parameter, the second traffic travel indication parameter, and the second movement parameter. The obtained fourth position parameter and the second position parameter obtained in the foregoing embodiments can be used as the second driving data.

In this embodiment of the present disclosure, the fourth position parameter refers to information related to a geographical position of the mobile object at the second moment. The fourth position parameter is different from the third position parameter mainly in that the fourth position parameter corresponds to the second moment, and the third position parameter corresponds to the first moment.

For the detailed descriptions to S401 shown in FIG. 11, reference may be made to S401 shown in FIG. 4. For the detailed descriptions to S301 as well as S303 and S304 shown in FIG. 11, reference may be made to S301 as well as S303 and S304 shown in FIG. 3. This is not described again herein.

In this embodiment of the present disclosure, the vehicle control terminal calculates the position parameter of the mobile object at the second moment based on the third position parameter, the second traffic travel indication parameter, and the second movement parameter of the mobile object at the first moment, and can quickly and easily obtain the second driving data, thereby improving a rate of subsequently constructing a driving image of the vehicle at the second moment based on the second driving data

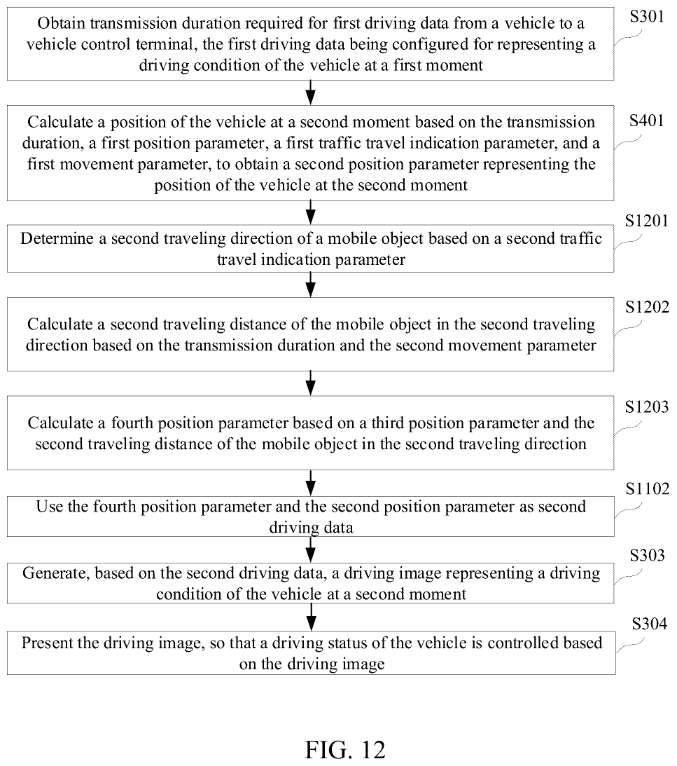

In an embodiment of the present disclosure, another vehicle data processing method is provided. The vehicle data processing method may be performed by the vehicle control terminal 202 as a control party. As shown in FIG. 12, the vehicle data processing method may include S1201 to S1203, S1102, S401, S301 as well as S303 and S304.

S1201 and S1203 are described in detail as follows:

S1201: Determine a second traveling direction of the mobile object based on the second traffic travel indication parameter.

In this embodiment of the present disclosure, the vehicle control terminal can determine the second traveling direction of the mobile object based on the second traffic travel indication parameter.

In this embodiment of the present disclosure, the second traveling direction is a traveling direction of the mobile object at a first moment. The traveling can be forward (for example, going straight, turning) or backward (for example, reversing).

In this embodiment of the present disclosure, in S1201, the determining a second traveling direction of the mobile object based on the second traffic travel indication parameter may include: analyzing the heading angle to obtain a traveling direction indicated by the heading angle; and using the traveling direction indicated by the heading angle as the second traveling direction. The specific process is similar to that of the foregoing embodiments, and reference may be made to the foregoing embodiments. This is not described again herein.

S1202: Calculate a second traveling distance of the mobile object in the second traveling direction based on the transmission duration and the second movement parameter.

In this embodiment of the present disclosure, the vehicle control terminal determines the second traveling direction of the mobile object based on the second traffic travel indication parameter, and then can calculate the second traveling distance of the mobile object in the second traveling direction based on the transmission duration and the second movement parameter.

In this embodiment of the present disclosure, the second traveling distance is a traveling distance that the mobile object moves in the second traveling direction at the first moment. For example, if the traveling direction is a straight direction, the traveling distance that the mobile object moves in the straight direction at the first moment is calculated, or if the traveling direction is a turning direction, the traveling distance that the mobile object moves in the turning direction at the second moment is calculated.

In an embodiment of the present disclosure, in S1202, the calculating a second traveling distance of the mobile object in the second traveling direction based on the transmission duration and the second movement parameter may include: calculating, if the second traveling direction is a straight direction and the movement parameter includes speed, a second traveling distance of the mobile object in the straight direction based on the transmission duration and the speed; and calculating, if the second traveling direction is a turning direction and the movement parameter includes the speed and an angular velocity, heading angle change amount based on the transmission duration and the angular velocity; calculating a turning radius based on the speed and the angular velocity; and calculating, based on the heading angle change amount and the turning radius, a second traveling distance of the mobile object in the turning direction. The specific process is similar to that of the foregoing embodiments, and reference may be made to the foregoing embodiments. This is not described again herein.

S1203: Calculate the fourth position parameter based on the third position parameter and the second traveling distance of the mobile object in the second traveling direction.

In this embodiment of the present disclosure, the vehicle control terminal calculates the second traveling distance of the mobile object in the second traveling direction based on the transmission duration and the second movement parameter, and then can calculate the fourth position parameter based on the third position parameter and the second traveling distance of the mobile object in the second traveling direction. In other words, in this embodiment of the present disclosure, the position parameter of the mobile object at the second moment is calculated based on the position parameter of the mobile object at the first moment and a traveling distance that the mobile object moves in the traveling direction within the transmission duration.

In an embodiment of the present disclosure, in S1203, the calculating the fourth position parameter based on the third position parameter and the second traveling distance of the mobile object in the second traveling direction may include: taking a position coordinate represented by the third position parameter as a starting point, and determining an ending point based on the starting point, the ending point is a position coordinate which is away from the starting point by the second traveling distance in the second traveling direction; and using the ending point as the fourth position parameter. The specific process is similar to that of the foregoing embodiments, and reference may be made to the foregoing embodiments. This is not described again herein.

For the detailed descriptions to S1102 shown in FIG. 12, reference may be made to S1102 shown in FIG. 11, for the detailed descriptions to S401 shown in FIG. 12, reference may be made to S401 shown in FIG. 4, and for the detailed descriptions to S301 as well as S303 and S304 shown in FIG. 12, reference may be made to S301 as well as S303 and S304 shown in FIG. 3. This is not described again herein.

In this embodiment of the present disclosure, the vehicle control terminal can quickly and easily obtain the position parameter of the mobile object at the second moment based on the position parameter of the mobile object at the first moment and the traveling distance that the mobile object moves in the traveling direction within the transmission duration, thereby providing support for subsequent construction of a driving image of the vehicle at the second moment.

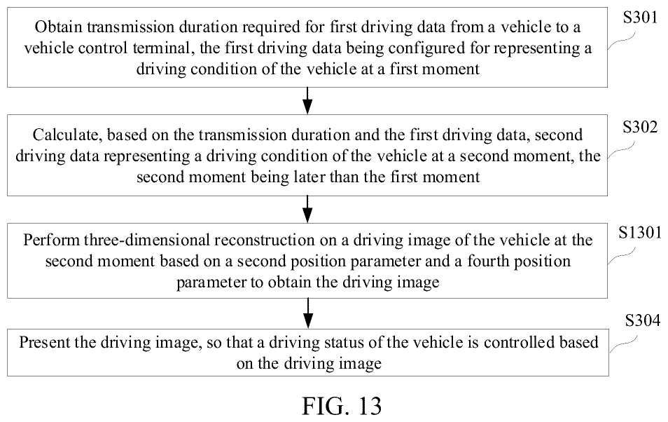

In an embodiment of the present disclosure, another vehicle data processing method is provided. The vehicle data processing method may be performed by the vehicle control terminal 202 as a control party. As shown in FIG. 13, the vehicle data processing method may include S1301, S301 and S302, and S304.

In this embodiment of the present disclosure, the second driving data includes a second position parameter of the vehicle at the second moment and a fourth position parameter of a mobile object at the second moment, and the mobile object is in a driving environment of the vehicle.

S1301 is described in detail as follows:

S1301: Perform three-dimensional reconstruction on the driving image of the vehicle at the second moment based on the second position parameter and the fourth position parameter to obtain the driving image.

In this embodiment of the present disclosure, the vehicle control terminal can perform the three-dimensional reconstruction on the driving image of the vehicle at the second moment based on the second position parameter and the fourth position parameter to obtain the driving image. In operation S1301, when the driving image at the second moment is generated, the driving image that is captured by an image collection device in a vehicle at the first moment and that is included in the first driving data is also included. The driving image obtained in this way includes a vehicle and mobile object, so that the driving image includes a key object (that is, the vehicle and mobile object) related to vehicle driving control, and a driver at the vehicle control terminal can better observe/understand a relative relationship between the vehicle and the mobile object, thereby helping to make more accurate control.

In an embodiment of the present disclosure, the vehicle control terminal can perform the three-dimensional reconstruction on the driving image of the vehicle at the second moment based on the second position parameter to obtain the driving image. The driving image obtained in this way includes the vehicle, and the three-dimensional reconstruction relies on less information, thereby improving efficiency of obtaining the driving image by three-dimensional reconstruction.

In an embodiment of the present disclosure, the driving data includes a fifth position parameter of a static object around (that is, located in the driving environment of the vehicle) the vehicle. The vehicle control terminal can perform the three-dimensional reconstruction on the driving image of the vehicle at the second moment based on the second position parameter and the fifth position parameter to obtain the driving image. The driving image obtained in this way includes a vehicle and static object, so that the driving image includes a key object (that is, the vehicle and static object) related to vehicle driving control, and a driver at the vehicle control terminal can better observe/understand a relative relationship between the vehicle and the static object, thereby helping to make more accurate control.

In an embodiment of the present disclosure, the first driving data includes a fifth position parameter of a static object located in the driving environment of the vehicle. The vehicle control terminal can perform the three-dimensional reconstruction on the driving image of the vehicle at the second moment based on the second position parameter, the fourth position parameter, and the fifth position parameter to obtain the driving image. The driving image obtained in this way includes a vehicle, a mobile object, and a static object, that is, includes more information, so that a driver at the vehicle control terminal can better observe/understand relative relationships between the vehicle, the mobile object, and the static object, thereby helping to make the most accurate control.

For the detailed descriptions to S301 and S302, and S304 shown in FIG. 13, reference may be made to S301 and S302, and S304 shown in FIG. 3. This is not described again herein.

In this embodiment of the present disclosure, the vehicle control terminal performs the three-dimensional reconstruction on the driving image of the vehicle at the second moment based on the second position parameter and the fourth position parameter to obtain the driving image. The driving image includes the vehicle and the mobile object. Therefore, the driver at the vehicle control terminal can better observe/understand the relative relationship between the vehicle and the mobile object, thereby making more accurate control. In addition, compared with performing the three-dimensional reconstruction based on the fifth position parameter, the three-dimensional reconstruction is more efficient in obtaining the driving image, thereby balancing control efficiency and control accuracy of the vehicle.

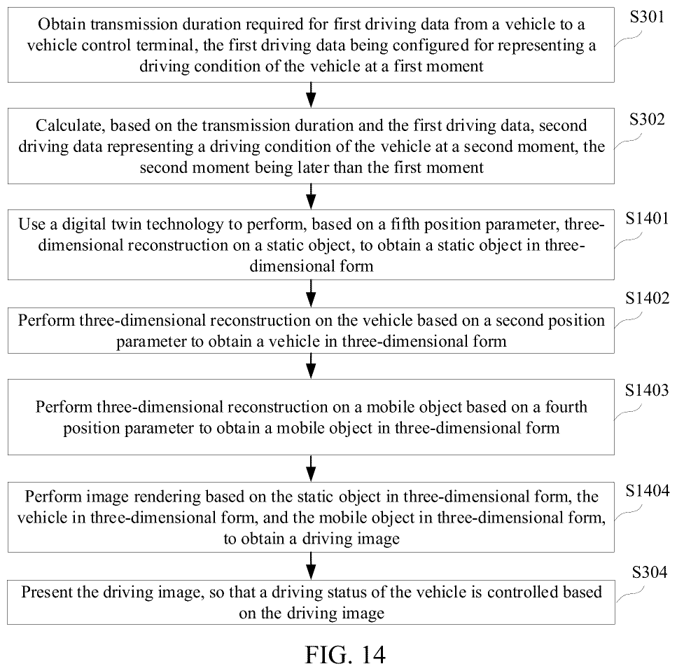

In an embodiment of the present disclosure, another vehicle data processing method is provided. The vehicle data processing method may be performed by the vehicle control terminal 202 as a control party. As shown in FIG. 14, the vehicle data processing method may include S1401 to S1404, S301 and S302, and S304.

In this embodiment of the present disclosure, the driving data includes a fifth position parameter of a static object located in the driving environment of the vehicle. As described in the foregoing embodiments, the vehicle control terminal performs the three-dimensional reconstruction on the driving image of the vehicle at the second moment based on the second position parameter, the fourth position parameter, and the fifth position parameter. The obtained driving image includes the most information, thereby helping the driver at the vehicle control terminal make the most accurate control. Therefore, in embodiments of the present disclosure, the process in which the vehicle control terminal performs the three-dimensional reconstruction on the driving image of the vehicle at the second moment based on the second position parameter, the fourth position parameter, and the fifth position parameter to obtain the driving image is described in detail.

S1401 and S1404 are described in detail as follows:

S1401: Use a digital twin technology to perform, based on the fifth position parameter, three-dimensional reconstruction on the static object, to obtain a static object in three-dimensional form.

The digital twin technology is a technology of establishing a multi-dimensional, multi-time-and-space-scale, multi-disciplinary, multi-physical quantity, and multi-probability digital entity (a dynamic virtual model) of a physical entity in a digital way to simulate and depict characteristics such as properties, behaviors, and rules of the physical entity in a real environment, and completing mapping in digital space (virtual space), to reflect an entire life cycle process of a corresponding physical entity. The main idea is to implement the fusion of real-time operating data and simulation operating data, that is, the fusion of virtual and real data.

Therefore, in this embodiment of the present disclosure, the vehicle control terminal can use the digital twin technology to implement the three-dimensional reconstruction on the driving image of the vehicle at the second moment to obtain the driving image. Since the digital twin technology can display information more clearly, for example, information such as surrounding vehicles, traffic lights, road markings, traffic signs, roadblocks, that are difficult to clearly identify due to the influence of light, rain, fog, and the like can be clearly displayed after three-dimensional reconstruction, the digital twin technology is used to implement the three-dimensional reconstruction on the driving image of the vehicle at the second moment, and the driving image obtained is clearer, so that the driver at the vehicle control terminal can better observe/understand a driving condition of the vehicle at the second moment, thereby helping to make accurate control.

In this embodiment of the present disclosure, the vehicle control terminal uses the digital twin technology to perform, based on the fifth position parameter, the three-dimensional reconstruction on the static object, to obtain a static object in three-dimensional form.

S1402: Perform three-dimensional reconstruction on the vehicle based on the second position parameter to obtain a vehicle in three-dimensional form.

In this embodiment of the present disclosure, the vehicle control terminal uses the digital twin technology to perform, based on the second position parameter, the three-dimensional reconstruction on the vehicle, to obtain the vehicle in three-dimensional form.

S1403: Perform three-dimensional reconstruction on the mobile object based on the fourth position parameter to obtain a 3D mobile object.

In this embodiment of the present disclosure, the vehicle control terminal uses the digital twin technology to perform, based on the fourth position parameter, the three-dimensional reconstruction on the mobile object, to obtain the 3D mobile object (also referred as mobile object in three-dimensional form).

S1401 to S1403 can be performed either first or later, or in parallel. In actual application, adjustments can be flexibly made according to specific application scenarios.

S1404: Perform image rendering based on the static object in three-dimensional form, the vehicle in three-dimensional form, and the mobile object in three-dimensional form, to obtain the driving image.

In this embodiment of the present disclosure, the vehicle control terminal obtains the static object in three-dimensional form, the vehicle in three-dimensional form, and the mobile object in three-dimensional form, and then performs image rendering based on the static object in three-dimensional form, the vehicle in three-dimensional form, and the mobile object in three-dimensional form, to obtain the driving image.

In an embodiment of the present disclosure, the vehicle control terminal can use the digital twin technology to perform, based on the second position parameter and the fourth position parameter, the three-dimensional reconstruction on the driving image of the vehicle at the second moment, to obtain the driving image. In one embodiment, the vehicle control terminal uses the digital twin technology to perform, based on the second position parameter, the three-dimensional reconstruction on the vehicle, to obtain the vehicle in three-dimensional form, uses the digital twin technology to perform, based on the fourth position parameter, the three-dimensional reconstruction on the mobile object, to obtain the mobile object in three-dimensional form, and then performs image rendering based on the vehicle in three-dimensional form and the mobile object in three-dimensional form, to obtain the driving image.

In one embodiment of the present disclosure, the vehicle control terminal can use the digital twin technology to perform, based on the second position parameter and the fifth position parameter, the three-dimensional reconstruction on the driving image of the vehicle at the second moment, to obtain the driving image. In one embodiment, the vehicle control terminal uses the digital twin technology to perform, based on the second position parameter, the three-dimensional reconstruction on the vehicle, to obtain the vehicle in three-dimensional form, uses the digital twin technology to perform, based on the fifth position parameter, the three-dimensional reconstruction on the static object, to obtain the static object in three-dimensional form, and then performs image rendering based on the vehicle in three-dimensional form and the static object in three-dimensional form, to obtain the driving image.

In an embodiment of the present disclosure, the vehicle control terminal can use a digital twin technology to perform, based on the second position parameter, the three-dimensional reconstruction on the driving image of the vehicle at the second moment, to obtain the driving image. In one embodiment, the vehicle control terminal uses the digital twin technology to perform, based on the second position parameter, the three-dimensional reconstruction on the vehicle, to obtain the vehicle in three-dimensional form, and then performs image rendering based on the vehicle in three-dimensional form, to obtain the driving image.

For the detailed descriptions to S301 and S302, and S304 shown in FIG. 14, reference may be made to S301 and S302, and S304 shown in FIG. 3. This is not described again herein.

In this embodiment of the present disclosure, the vehicle control terminal uses the digital twin technology to perform, based on the second position parameter, the fourth position parameter, and the fifth position parameter, the three-dimensional reconstruction on the driving image of the vehicle at the second moment. The driving image obtained is clearer, so that the driver at the vehicle control terminal can better observe/understand the driving condition of the vehicle at the second moment, thereby helping to make accurate control.

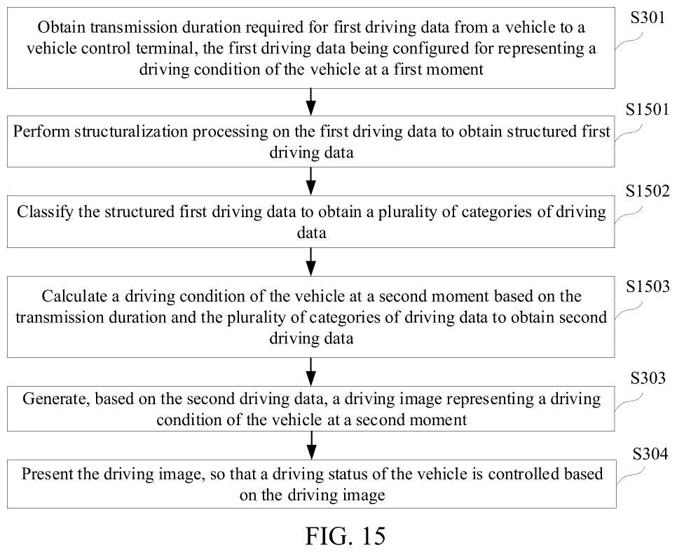

In an embodiment of the present disclosure, another vehicle data processing method is provided. The vehicle data processing method may be performed by the vehicle control terminal 202 as a control party. As shown in FIG. 15, the vehicle data processing method may include S1501 to S1503, S301 as well as S303 and S304.

S1501 to S1503 are described in detail as follows:

S1501: Perform structuralization processing on the first driving data to obtain structured first driving data.

In this embodiment of the present disclosure, the vehicle control terminal obtains the driving data of the vehicle, and then can perform the structuralization processing on the driving data to obtain the structured driving data.

The structuralization processing in this embodiment of the present disclosure refers to converting unstructured data or semi-structured data into structured data. The unstructured data is data that has an irregular or incomplete data structure, does not have a predefined data model, and is inconvenient to be represented by using a two-dimensional logic table in a database. The unstructured data may include all formats of official documents, text, pictures, XML, HTML, various reports, images, audio, videos, and the like. Correspondingly, the structured data is data that has a regular or complete data structure, has a predefined data model, and can be conveniently represented by using the two-dimensional logical table in the database. The semi-structured data is between the unstructured data and the structured data. Part of the semi-structured data is similar to the unstructured data and part of the semi-structured data is similar to the structured data. Therefore, structuralization processing needs to be performed on the semi-structured data to obtain structured data.

In an embodiment of the present disclosure, in S1501, the process of performing structuralization processing on the first driving data to obtain structured first driving data may include: preprocessing the first driving data to obtain preprocessed first driving data, and performing structuralization processing on the preprocessed first driving data to obtain structured first driving data. The preprocessing includes at least one of abnormal data removal processing and duplicate data removal processing.

S1502: Classify the structured first driving data to obtain a plurality of categories of driving data.

In this embodiment of the present disclosure, the vehicle control terminal performs the structuralization processing on the first driving data to obtain the structured driving data, and then classifies the structured first driving data to obtain the plurality of categories of driving data.

In an embodiment of the present disclosure, in S1502, the process of classifying the structured first driving data to obtain a plurality of categories of driving data may include: classifying the structured first driving data based on vehicle categories, mobile object categories, and static object categories to obtain driving data corresponding to the three categories respectively.

The structured first driving data is classified based on the vehicle categories, mobile object categories, and static object categories to obtain the driving data corresponding to the three categories, and then each category can be further subdivided. The driving data corresponding to the vehicle categories is subdivided into data of position information categories, traffic travel indication categories, movement categories, and the like. The driving data corresponding to the mobile object categories is subdivided into data of the position information categories, the traffic travel indication categories, the movement categories, and the like. The driving data corresponding to the static object categories is subdivided into data of the position information categories, the traffic travel indication categories, the movement categories, and the like.

Only a few categories are used as examples for descriptions. In actual application, adjustments can be flexibly made according to specific application scenarios.

S1503: Calculate the driving condition of the vehicle at the second moment based on the transmission duration and the plurality of categories of driving data to obtain the second driving data.

In this embodiment of the present disclosure, the vehicle control terminal classifies the structured driving data to obtain the plurality of categories of driving data, and then can calculate the driving condition of the vehicle at the second moment based on the transmission duration and the plurality of categories of driving data to obtain the second driving data.

For the detailed descriptions to S301 as well as S303 and S304 shown in FIG. 15, reference may be made to S301 as well as S303 and S304 shown in FIG. 3. This is not described again herein.

In this embodiment of the present disclosure, the vehicle control terminal performs structuralization processing on and classifies the obtained first driving data, which can improve a rate of subsequent calculating the driving condition of the vehicle at the second moment based on the transmission duration and the plurality of categories of driving data to obtain the second driving data, thereby improving a driving image construction rate and a vehicle control rate, and ensuring driving safety of the vehicle.

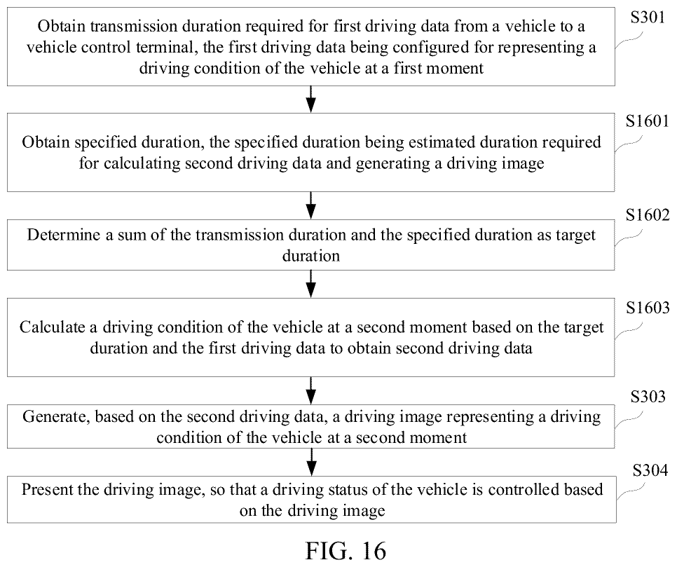

In an embodiment of the present disclosure, another vehicle data processing method is provided. The vehicle data processing method may be performed by the vehicle control terminal 202 as a control party. As shown in FIG. 16, the vehicle data processing method may include S1601 to S1603, S301 as well as S303 and S304.

S1601 to S1603 are described in detail as follows:

S1601: Obtain specified duration. The specified duration is estimated duration required for calculating the second driving data and generating the driving image.

In this embodiment of the present disclosure, the vehicle control terminal can obtain the specified duration. The specified duration is the estimated duration required for calculating the driving condition of the vehicle at the second moment and constructing the driving image. In other words, in this embodiment of the present disclosure, in addition to the transmission duration, the specified duration for reconstructing the driving image is also considered.

S1602: Determine a sum of the transmission duration and the specified duration as target duration.

In this embodiment of the present disclosure, the vehicle control terminal obtains the specified duration, and then can determine the target duration based on the transmission duration and the specified duration. The target duration is longer than the transmission duration.

In an embodiment of the present disclosure, in S1602, the determining a sum of the transmission duration and the specified duration as target duration may include: summing the transmission duration and the specified duration to obtain the target duration.

S1603: Calculate the driving condition of the vehicle at the second moment based on the target duration and the first driving data to obtain the second driving data.

In this embodiment of the present disclosure, the vehicle control terminal determines the target duration based on the transmission duration and the specified duration, and then can calculate the driving condition of the vehicle at the second moment based on the target duration and the first driving data to obtain the second driving data.

In this embodiment of the present disclosure, the second moment is associated with the first moment and the target duration, and may be a corresponding moment after the target duration from the first moment. For example, if the first moment is T1, the transmission duration is T0′, and the specified duration is T1′, then the second moment is: T2=T1+T0′+T1′.

For the detailed descriptions to S301 as well as S303 and S304 shown in FIG. 16, reference may be made to S301 as well as S303 and S304 shown in FIG. 3. This is not described again herein.

In this embodiment of the present disclosure, the vehicle control terminal considers two aspects of the transmission duration and estimated calculation duration (that is, the specified duration), so that the second driving data obtained by calculating the driving condition of the vehicle at the second moment based on the transmission duration, the specified duration, and the first driving data is more matched with the current moment, further avoiding a phenomenon of driving image hysteresis, thereby improving accuracy of the driving image.

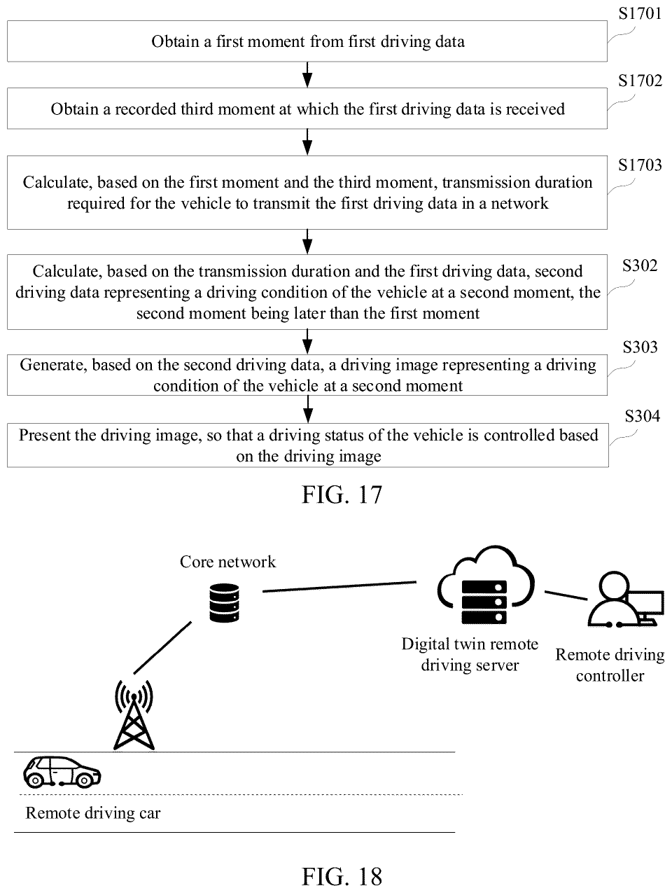

In an embodiment of the present disclosure, another vehicle data processing method is provided. The vehicle data processing method may be performed by the vehicle control terminal 202 as a control party. As shown in FIG. 17, the vehicle data processing method may include S1701 to S1703, and S302 to S304.

S1701 to S1703 are described in detail as follows:

S1701: Obtain the first moment from the first driving data.

Since the first driving data is configured for representing the driving condition of the vehicle at the first moment, the vehicle control terminal in this embodiment of the present disclosure can obtain the first moment from the first driving data.

S1702: Obtain a recorded third moment at which the first driving data is received.

In this embodiment of the present disclosure, when the vehicle control terminal receives the first driving data, the receiving moment can be recorded. The receiving moment is referred to as the third moment. Therefore, in this embodiment of the present disclosure, the vehicle control terminal can obtain the recorded third moment.

S1701 to S1702 can be performed either first or later, or in parallel. In actual application, adjustments can be flexibly made according to specific application scenarios.

S1703: Calculate, based on the first moment and the third moment, the transmission duration required for the vehicle to transmit the first driving data in a network.

In this embodiment of the present disclosure, the vehicle control terminal obtains the first moment and the third moment, and then can calculate, based on the first moment and the third moment, the transmission duration required for the vehicle to transmit the first driving data in the network.

For the detailed descriptions to S302 to S304 shown in FIG. 17, reference may be made to S302 to S304 shown in FIG. 3. This is not described again herein.

In this embodiment of the present disclosure, the vehicle control terminal can quickly and easily obtain, based on the first moment obtained from the first driving data and the recorded third moment at which the first driving data is received, the transmission duration required for the vehicle to transmit the first driving data in the network, thereby providing support for subsequent construction of the driving image of the vehicle at the second moment.

A specific scenario of an embodiment of the present disclosure is described in detail below.

FIG. 18 mainly includes a core network, a base station, a digital twin remote driving server, a remote driving controller (a remote driver), and a remote driving car.

The core network may be a 5G core network. The core network communicates and interacts with the base station to form a network, thereby providing support for mutual communication between the digital twin remote driving server, remote driving controller (remote driver), and remote driving car.

The digital twin remote driving server may be a server using a digital twin technology, which is mainly configured to obtain the transmission duration for transmitting first driving data of the remote driving car to be transmitted in the network. The first driving data is configured for representing a driving condition of the remote driving car at a first moment. Then, a driving condition of the remote driving car at a second moment is calculated based on the transmission duration and the first driving data, to obtain second driving data. The second moment is later than the first moment. Next, a driving image of the remote driving car at the second moment is constructed based on the second driving data to obtain a driving image. After that, the constructed driving image is sent to the remote driving controller.

The remote driving controller is mainly configured to receive the driving image sent by the digital twin remote driving server and present the driving image, so that a remote driver can control a driving status of the remote driving car based on the driving image.

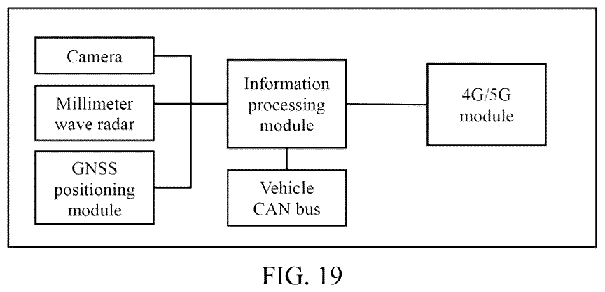

The remote driving car is mainly configured to receive a control instruction sent by the remote driving controller to perform a corresponding operation according to the control instruction. Refer to FIG. 19. In an embodiment of the present disclosure, the remote driving car mainly includes a camera, a millimeter wave radar, a GNSS positioning module, a vehicle CAN bus, an information processing module, and a 4G/5G module. The camera is mainly configured to collect a real-time driving image of the remote driving car. The millimeter wave radar is mainly configured to sense relative positions of the remote driving car and surrounding vehicles, calculate speed of the surrounding vehicles, and the like. The GNSS positioning module is mainly configured to collect position information, speed, a heading angle, and the like of a vehicle. The vehicle CAN bus is mainly configured for longitudinal acceleration, lateral acceleration, a yaw angular velocity, and the like of a vehicle. The information processing module is mainly configured to obtain information transmitted by the camera, millimeter wave radar, GNSS positioning module, vehicle CAN bus, and 4G/5G module, and process the information accordingly to obtain the first driving data, and the like. The 4G/5G module is mainly configured to provide network support.

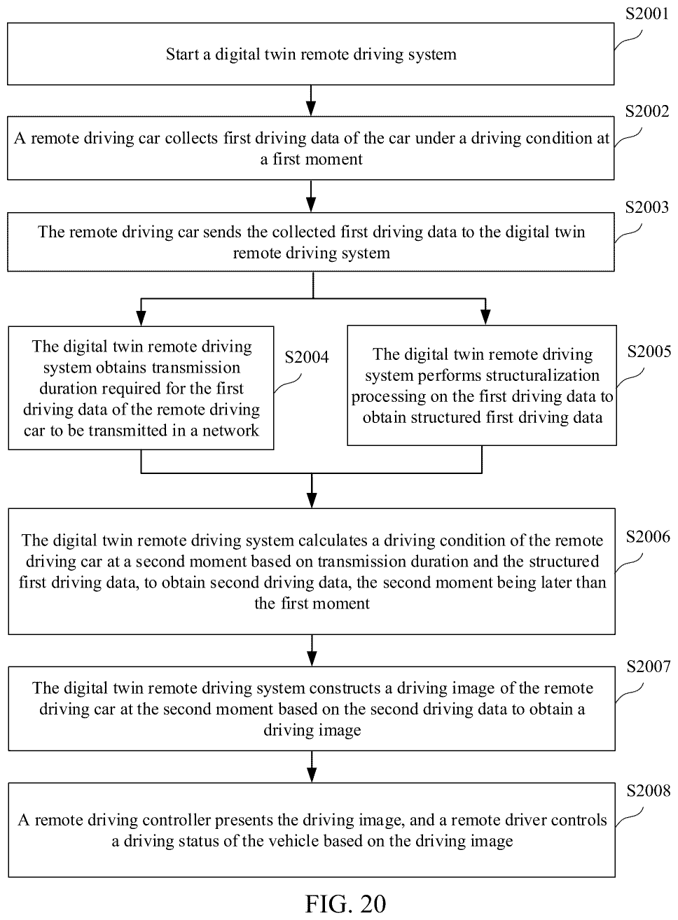

Based on the implementation environment shown in FIG. 18 and FIG. 19, refer to FIG. 20. FIG. 20 is a flowchart of a vehicle data processing method shown in an embodiment of the present disclosure. As shown in FIG. 20, the vehicle data processing method includes at least S2001 to S2008, and details are as follows:

S2001: Start a digital twin remote driving system.

S2002: The remote driving car collects the first driving data of the car under the driving condition at the first moment.

In one embodiment, the camera of the remote driving car collects image information of the surrounding environment and vehicles, the millimeter wave radar senses the relative positions of the remote driving car and the surrounding vehicles, calculates the speed of surrounding vehicles, and the like, the GNSS positioning module collects the position information, speed, heading angle, and the like of the vehicle, and the vehicle CAN bus obtains the longitudinal acceleration, lateral acceleration, yaw angular velocity, and the like of the vehicle.

S2003: The remote driving car sends the collected first driving data to the digital twin remote driving system.

In one embodiment, the remote driving car sends the collected first driving data to the digital twin remote driving system in the form of a data packet. The data packet includes timestamp information (that is, corresponding to the first moment) when the remote driving car collects the first driving data.

S2004: The digital twin remote driving system obtains transmission duration required for the first driving data of the remote driving car to be transmitted in the network.

In one embodiment, the digital twin remote driving system obtains, based on a receiving moment (that is, corresponding to the third moment) and the first moment, the transmission duration required for the first driving data to be transmitted in the network.

S2005: The digital twin remote driving system performs structuralization processing on the first driving data to obtain structured first driving data.

In one embodiment, the structured first driving data includes:
(a) remote driving car data: a position, speed, and a heading angle of a vehicle; historical trajectory of the vehicle; lateral acceleration, longitudinal acceleration, a yaw angular velocity, a steering angle, and the like of the vehicle;
(b) surrounding vehicle data: a type, color, and size of a vehicle; a position, speed, and a heading angle of the vehicle; a historical trajectory of the vehicle;
(c) surrounding pedestrian data: a type, a position, a traveling direction of a pedestrian, and the like; and
(d) surrounding traffic environment data: road conditions; lane line conditions; roadside trees, railings and other landmarks; traffic lights and traffic signs; weather condition lights, and the like.

S2006: The digital twin remote driving system calculates the driving condition of the remote driving car at the second moment based on the transmission duration and the structured first driving data, to obtain the second driving data. The second moment is later than the first moment.

S2007: The digital twin remote driving system constructs the driving image of the remote driving car at the second moment based on the second driving data to obtain the driving image.

In one embodiment, the digital twin remote driving system constructs the driving image, and then the driving image can be sent to the remote driving controller.

In one embodiment, the digital twin remote driving system can also be deployed on the remote driving controller, so that the digital twin remote driving system constructs the driving image, and the remote driving controller can obtain the driving image.

S2008: The remote driving controller presents the driving image, and the remote driver controls the driving status of the remote driving car based on the driving image.

For the detailed description to S2001 to S2008 shown in FIG. 20, reference may be made to the foregoing embodiments. This is not described again herein.

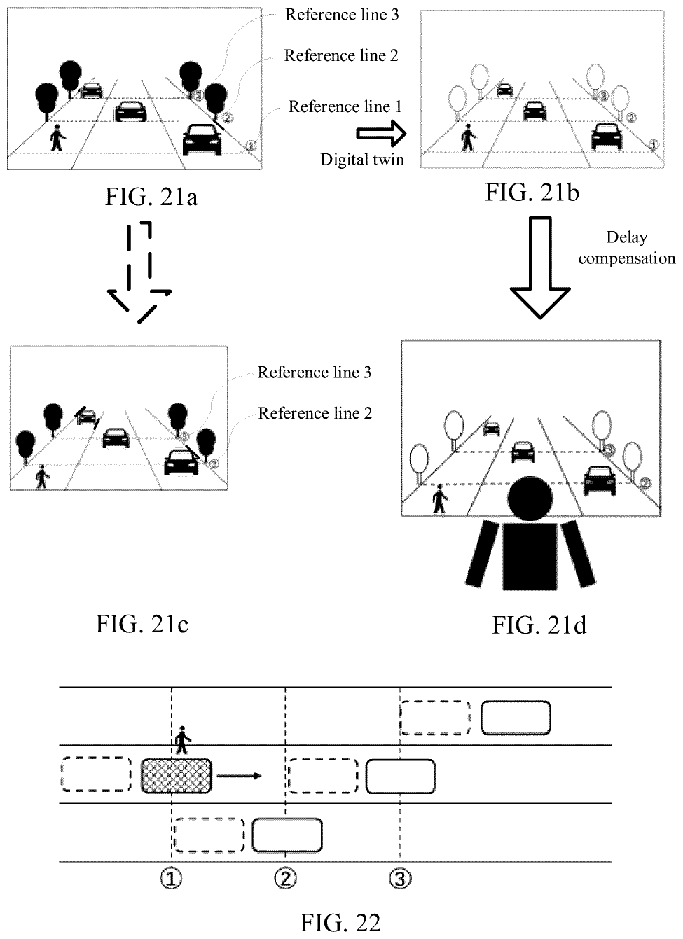

FIG. 21a and FIG. 21c are actual driving conditions of a remote driving car. FIG. 21a is a perspective of a camera of the remote driving car at a first moment, and FIG. 21c is a perspective of the camera of the remote driving car at a second moment. FIG. 21b and FIG. 21d are driving conditions of the remote driving car viewed on a vehicle control terminal. FIG. 21b is a perspective of the driver at the vehicle control terminal without delay compensation processing, and FIG. 21d is a perspective of the driver at the vehicle control terminal after delay compensation processing.

FIG. 22 is a comparison diagram before and after the delay compensation processing. A filled area refers to the vehicle, and an unfilled area refers to other vehicles. Dashed lines are positions before the delay compensation, and solid lines are positions after the delay compensation. It can be learned that a driving image after the delay compensation processing is closer to actual driving of the remote driving car, which helps the driver to make more accurate driving control of the remote driving car.

In this embodiment of the present disclosure, when a relative distance and speed of a mobile object other than the vehicle (such as vehicles ahead and pedestrians) remain unchanged, the speed of the vehicle can be increased to a specific extent, as described in detail as follows:

TTC (time to collision) is the time it takes for the vehicle to collide with the vehicle ahead/pedestrian/road edge or the like.

TTC=Relative distance/relative speed.

Relative speed=Vehicle speed−vehicle ahead/pedestrian speed.

In remote driving, the minimum TTC is determined by three parts of time.

TTC=Driver reaction time+vehicle mechanical response time+reserved system transmission delay.

In embodiments of the present disclosure, when influence of the system transmission delay is reduced, the minimum TTC can be reduced. Therefore, when the relative distance and the vehicle ahead/pedestrian speed are determined, the vehicle speed can be increased to a specific extent.

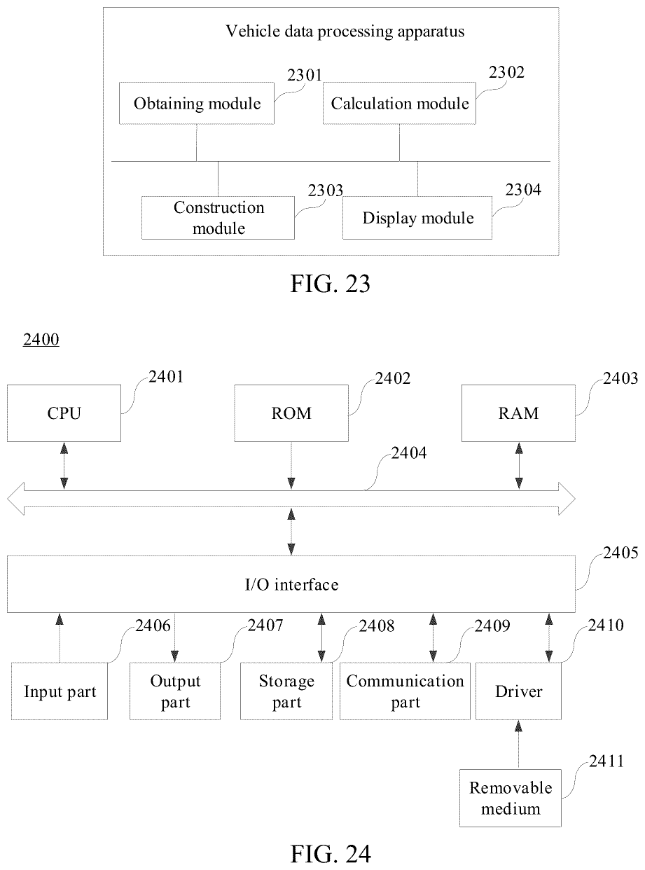

FIG. 23 is a block diagram of a vehicle data processing apparatus according to an embodiment of the present disclosure. As shown in FIG. 23, the vehicle data processing apparatus includes:
an obtaining module 2301, configured to obtain transmission duration for transmitting first driving data from a vehicle to a vehicle control terminal, the first driving data representing a driving condition of the vehicle at a first moment;
a calculation module 2302, configured to calculate, based on the transmission duration and the first driving data, second driving data for representing a driving condition of the vehicle at a second moment, the second moment being later than the first moment; and
a construction module 2303, configured to generate, based on the second driving data, a driving image representing the driving condition of the vehicle at the second moment.

In some embodiments, the apparatus may further include a display module 2304, configured to present the driving image, so that the vehicle control terminal controls a driving status of the vehicle based on the driving image.

In an embodiment of the present disclosure, the first driving data includes a first position parameter indicating a position of the vehicle at the first moment, a first traffic travel indication parameter indicating a traveling direction of the vehicle, and a first movement parameter indicating a motion state of the vehicle. The calculation module 2302 is specifically configured to:
calculate a position of the vehicle at the second moment based on the transmission duration, the first position parameter, the first traffic travel indication parameter, and the first movement parameter, to obtain a second position parameter; and
use the second position parameter as the second driving data.

In an embodiment of the present disclosure, the calculation module 2302 is specifically configured to:
determine a first traveling direction of the vehicle based on the first traffic travel indication parameter;
calculate, based on the transmission duration and the first movement parameter, a first traveling distance of the vehicle in the first traveling direction; and
calculate the second position parameter based on the first position parameter and the first traveling distance of the vehicle in the first traveling direction.

In an embodiment of the present disclosure, the first traffic travel indication parameter includes a heading angle. The calculation module 2302 is specifically configured to:
analyze the heading angle to obtain a traveling direction indicated by the heading angle; and
use the traveling direction indicated by the heading angle as the first traveling direction.

In an embodiment of the present disclosure, the calculation module 2302 is specifically configured to:
calculate, if the first traveling direction is a straight direction and the movement parameter includes speed, a first traveling distance of the vehicle in the straight direction based on the transmission duration and the speed; and
calculate, if the first traveling direction is a turning direction and the movement parameter includes the speed and an angular velocity, heading angle change amount based on the transmission duration and the angular velocity; calculate a turning radius based on the speed and the angular velocity; and calculate, based on the heading angle change amount and the turning radius, a first traveling distance of the vehicle in the turning direction.

In an embodiment of the present disclosure, the calculation module 2302 is specifically configured to:
take a position coordinate represented by the first position parameter as a starting point, and determining, as the second position parameter, a position coordinate which is away from the starting point by the first traveling distance in the first traveling direction.

In an embodiment of the present disclosure, the first driving data further includes an environmental parameter of the vehicle at the first moment, the environmental parameter includes a third position parameter for indicating a position of a mobile object around the vehicle at the first moment, a second traffic travel indication parameter indicating a traveling direction of the mobile object, and a second movement parameter indicating a motion state of the mobile object. The calculation module 2302 is specifically configured to:
calculate the position of the mobile object at the second moment based on the transmission duration, the third position parameter, the second traffic travel indication parameter, and the second movement parameter, to obtain a fourth position parameter; and
use the fourth position parameter and the second position parameter as the second driving data.

In an embodiment of the present disclosure, the calculation module 2302 is specifically configured to:
determine a second traveling direction of the mobile object based on the second traffic travel indication parameter;
calculate a second traveling distance of the mobile object in the second traveling direction based on the transmission duration and the second movement parameter; and
calculate the fourth position parameter based on the third position parameter and the second traveling distance of the mobile object in the second traveling direction.

In an embodiment of the present disclosure, the second driving data includes a second position parameter of the vehicle at the second moment and a fourth position parameter of a mobile object at the second moment, and the mobile object is in a driving environment of the vehicle. The construction module 2303 is specifically configured to:
perform three-dimensional reconstruction on the driving image of the vehicle at the second moment based on the second position parameter and the fourth position parameter to obtain the driving image.

In an embodiment of the present disclosure, the driving data includes a fifth position parameter of a static object located in the driving environment of the vehicle. The construction module 2303 is specifically configured to:
use a digital twin technology to perform, based on the fifth position parameter, three-dimensional reconstruction on the static object, to obtain a static object in three-dimensional form;
perform three-dimensional reconstruction on the vehicle based on the second position parameter to obtain a vehicle in three-dimensional form;
perform three-dimensional reconstruction on the mobile object based on the fourth position parameter to obtain a mobile object in three-dimensional form; and
perform image rendering based on the static object in three-dimensional form, the vehicle in three-dimensional form, and the mobile object in three-dimensional form, to obtain the driving image.

In an embodiment of the present disclosure, the calculation module 2302 is specifically configured to:
perform structuralization processing on the driving data to obtain structured first driving data;
classify the structured driving data to obtain a plurality of categories of driving data; and
calculate the driving condition of the vehicle at the second moment based on the transmission duration and the plurality of categories of driving data to obtain the second driving data.

In an embodiment of the present disclosure, the calculation module 2302 is specifically configured to:
obtain specified duration, the specified duration being estimated duration required for calculating the second driving data and generating the driving image;
determine a sum of the transmission duration and the specified duration as target duration; and
calculate the driving condition of the vehicle at the second moment based on the target duration and the driving data to obtain the second driving data.

In an embodiment of the present disclosure, the obtaining module 2301 is specifically configured to:
obtain the first moment from the first driving data;
obtain a recorded third moment at which the first driving data is received; and
calculate, based on the first moment and the third moment, the transmission duration required for the vehicle to transmit the first driving data in a network.

In an embodiment of the present disclosure, the vehicle is a remote driving vehicle. The display module 2304 is specifically configured to
display the driving image on the vehicle control terminal, so that a driving operation of the vehicle can be controlled based on the displayed driving image.

The apparatus provided in the foregoing embodiments is of the same idea as the method provided in the foregoing embodiment. A specific manner in which each module and unit perform the operation is described in detail in the method embodiment.

An embodiment of the present disclosure provides an electronic device, including: one or more processors; and a memory, configured to store one or more programs, the one or more programs, when executed by the one or more processors, enabling the electronic device to perform the foregoing vehicle data processing method.

FIG. 24 is a schematic diagram of a structure of a computer system suitable for implementing an electronic device according to an embodiment of the present disclosure.

The computer system 2400 of the electronic device shown in FIG. 24 is merely an example, and does not constitute any limitation on functions and use ranges of this embodiment of the present disclosure.

As shown in FIG. 24, the computer system 2400 includes a central processing unit (CPU) 2401, which may perform various suitable actions and processing based on a program stored in a read-only memory (ROM) 2402 or a program loaded from a storage part 2408 into a random access memory (RAM) 2403, for example, perform the method described in the foregoing embodiments. The RAM 2403 further stores various programs and data required for system operations. The CPU 2401, the ROM 2402, and the RAM 2403 are connected to each other through a bus 2404. An input/output (I/O) interface 2405 is also connected to the bus 2404.

The following components are connected to the I/O interface 2405: an input part 2406 including a keyboard, a mouse, or the like, an output part 2407 including a cathode ray tube (CRT), a liquid crystal display (LCD), a speaker, or the like, a storage part 2408 including a hard disk, or the like, and a communication part 2409 including, for example, a local area network (LAN) card, a modem, and another network interface card. The communication part 2409 performs communication processing over a network such as the Internet. A driver 2410 is also connected to the I/O interface 2405 as required. A removable medium 2411, such as a magnetic disk, an optical disc, a magneto-optical disk, or a semiconductor memory, is installed on the drive 2410 as required, so that a computer program read from the removable medium is installed into the storage part 2408 as required.

Particularly, according to embodiments of the present disclosure, the processes described above by referring to the flowcharts may be implemented as computer software programs. For example, an embodiment of the present disclosure includes a computer program product. The computer program product includes a computer program carried on a computer-readable medium. The computer program includes a computer program configured for performing the method shown in the flowchart. In such an embodiment, the computer program may be downloaded and installed from a network through the communication part 2409, and/or installed from the removable medium 2411. When the computer program is executed by the central processing unit (CPU) 2401, the various functions defined in the system of the present disclosure are executed.

The computer-readable medium shown in embodiments of the present disclosure may be a computer-readable signal medium or a computer-readable storage medium or any combination of the two. The computer-readable medium may be, for example, an electric, a magnetic, an optical, an electromagnetic, an infrared, or a semi-conductive system, apparatus, or component, or any combination of the above. A more specific example of the computer-readable medium may include but is not limited to: an electrical connection having one or more wires, a portable computer magnetic disk, a hard disk, a random access memory (RAM), a read-only memory (ROM), an erasable programmable read-only memory (EPROM), a flash memory, an optical fiber, a portable compact disk read-only memory (CD-ROM), an optical storage device, a magnetic storage device, or any appropriate combination thereof. In the present disclosure, the computer-readable medium may be any tangible medium including or storing a program, and the program may be used by or used in combination with an instruction execution system, an apparatus, or a device. In the present disclosure, the computer-readable signal medium may include a data signal transmitted in a baseband or as part of a carrier, and a computer-readable computer program is stored thereon. A data signal propagated in such a way may use a plurality of forms, including, but not limited to, an electromagnetic signal, an optical signal, or any appropriate combination thereof. The computer-readable signal medium may be further any computer-readable medium in addition to a computer-readable storage medium. The computer-readable medium may send, propagate, or transmit a program that is used by or used in combination with an instruction execution system, an apparatus, or a device. The computer program included in the computer-readable medium may be transmitted by using any suitable medium, including, but not limited to: a wireless medium, a wired medium, and the like, or any appropriate combination thereof.

The flowcharts and block diagrams in the accompanying drawings illustrate exemplary system architectures, functions and operations that may be implemented by a system, a method, and a computer program product according to various embodiments of the present disclosure. Each box in a flowchart or a block diagram may represent a module, a program segment, or a part of code. The module, the program segment, or the part of code includes one or more executable instructions used for implementing specified logic functions. In some alternative implementations, the functions annotated in boxes may alternatively occur in a sequence different from that annotated in the accompanying drawings. For example, two boxes shown in succession may actually be performed basically in parallel, and sometimes the two boxes may be performed in a reverse sequence. This is determined by a related function. Each box in a block diagram or a flowchart and a combination of boxes in the block diagram or the flowchart may be implemented by using a dedicated hardware-based system configured to perform a specified function or operation, or may be implemented by using a combination of dedicated hardware and a computer instruction.

A related unit described in this embodiment of the present disclosure may be implemented in a software manner, or may be implemented in a hardware manner, and the unit described can also be provided in a processor. Names of the units do not constitute a limitation on the units in a specific case.

According to another aspect of the present disclosure, a computer-readable medium is provided, having a computer program stored thereon, the computer program, when executed by a processor, implementing the foregoing vehicle data processing method. The computer-readable medium may be included in the electronic device described in the foregoing embodiments, or may exist alone and is not disposed in the electronic device.

According to another aspect of the present disclosure, a computer program product or a computer program is further provided. The computer program product or the computer program includes computer instructions stored on a computer-readable medium. A processor of a computer device reads the computer instructions from the computer-readable medium, and the processor executes the computer instructions, so that the computer device performs the vehicle data processing method provided in the foregoing embodiments.

The foregoing descriptions are merely preferable exemplary embodiments of the present disclosure, and are not intended to limit the embodiments of the present disclosure. A person of ordinary skill in the art can make corresponding modifications and variations with ease without departing from the spirit and scope of the embodiments of the present disclosure. Therefore, the protection scope of the present disclosure shall be subject to the protection scope of the claims.

What is claimed is:

1. A vehicle data processing method, comprising:
obtaining transmission duration for transmitting first driving data from a vehicle to a vehicle control terminal, the first driving data representing a driving condition of the vehicle at a first moment;
calculating, based on the transmission duration and the first driving data, second driving data for representing a driving condition of the vehicle at a second moment, the second moment being later than the first moment; and
generating, based on the second driving data, a driving image representing the driving condition of the vehicle at the second moment.

2. The method according to claim 1, further comprising: presenting the driving image, so that the vehicle control terminal controls a driving status of the vehicle based on the driving image.

3. The method according to claim 1, wherein the first driving data comprises a first position parameter indicating a position of the vehicle at the first moment, a first traffic travel indication parameter indicating a first traveling direction of the vehicle, and a first movement parameter indicating a motion state of the vehicle; and the calculating, based on the transmission duration and the first driving data, second driving data for representing a driving condition of the vehicle at a second moment comprises:
calculating a position of the vehicle at the second moment based on the transmission duration, the first position parameter, the first traffic travel indication parameter, and the first movement parameter, to obtain a second position parameter; and
using the second position parameter as the second driving data.

4. The method according to claim 3, wherein the calculating a position of the vehicle at the second moment based on the transmission duration, the first position parameter, the first traffic travel indication parameter, and the first movement parameter comprises:
determining the first traveling direction of the vehicle based on the first traffic travel indication parameter;
calculating, based on the transmission duration and the first movement parameter, a first traveling distance of the vehicle in the first traveling direction; and
calculating the second position parameter based on the first position parameter and the first traveling distance of the vehicle in the first traveling direction.

5. The method according to claim 4, wherein the first traffic travel indication parameter comprises a heading angle; and the determining a first traveling direction of the vehicle based on the first traffic travel indication parameter comprises:
analyzing the first traveling direction based on the heading angle.

6. The method according to claim 4, wherein the calculating, based on the transmission duration and the first movement parameter, a first traveling distance of the vehicle in the first traveling direction comprises:
calculating, in response to that the first traveling direction is a straight direction and the first movement parameter comprises speed, a first traveling distance of the vehicle in the straight direction based on the transmission duration and the speed; and
in response to that the first traveling direction is a turning direction and the first movement parameter comprises the speed and an angular velocity,
calculating heading angle change amount based on the transmission duration and the angular velocity,
calculating a turning radius based on the speed and the angular velocity, and
calculating, based on the heading angle change amount and the turning radius, a first traveling distance of the vehicle in the turning direction.

7. The method according to claim 4, wherein the calculating the second position parameter based on the first position parameter and the first traveling distance of the vehicle in the first traveling direction comprises:
taking a position coordinate represented by the first position parameter as a starting point, and determining, as the second position parameter, a position coordinate which is away from the starting point by the first traveling distance in the first traveling direction.

8. The method according to claim 3, wherein the first driving data further comprises an environmental parameter of the vehicle at the first moment, and the environmental parameter comprises a third position parameter for indicating a position of a mobile object around the vehicle at the first moment, a second traffic travel indication parameter indicating a traveling direction of the mobile object, and a second movement parameter indicating a motion state of the mobile object; and the calculating, based on the transmission duration and the first driving data, second driving data for representing a driving condition of the vehicle at a second moment further comprises:
calculating a position of the mobile object at the second moment based on the transmission duration, the third position parameter, the second traffic travel indication parameter, and the second movement parameter, to obtain a fourth position parameter; and
using the fourth position parameter and the second position parameter as the second driving data.

9. The method according to claim 8, wherein the calculating a position of the mobile object at the second moment based on the transmission duration, the third position parameter, the second traffic travel indication parameter, and the second movement parameter, to obtain a fourth position parameter comprises:
determining a second traveling direction of the mobile object based on the second traffic travel indication parameter;
calculating a second traveling distance of the mobile object in the second traveling direction based on the transmission duration and the second movement parameter; and
calculating the fourth position parameter based on the third position parameter and the second traveling distance.

10. The method according to claim 1, wherein the second driving data comprises a second position parameter of the vehicle at the second moment and a fourth position parameter of a mobile object around the vehicle at the second moment; and the generating, based on the second driving data, a driving image representing the driving condition of the vehicle at the second moment comprises:
performing three-dimensional reconstruction on the driving image of the vehicle at the second moment based on the second position parameter and the fourth position parameter to obtain the driving image.

11. The method according to claim 10, wherein the first driving data comprises a fifth position parameter of a static object around the vehicle; and the performing three-dimensional reconstruction on the driving image of the vehicle at the second moment based on the second position parameter and the fourth position parameter comprises:
using a digital twin technology to perform, based on the fifth position parameter, three-dimensional (3D) reconstruction on the static object, to obtain a static object in three-dimensional form;
performing three-dimensional reconstruction on the vehicle based on the second position parameter to obtain a vehicle in three-dimensional form;
performing three-dimensional reconstruction on the mobile object based on the fourth position parameter to obtain a 3D mobile object in three-dimensional form; and
performing image rendering on the static object in three-dimensional form, the vehicle in three-dimensional form, and the 3D mobile object, to obtain the driving image.

12. The method according to claim 1, wherein the calculating, based on the transmission duration and the first driving data, second driving data for representing a driving condition of the vehicle at a second moment comprises:
performing structuralization processing on the first driving data to obtain structured first driving data;
classifying the structured first driving data to obtain a plurality of categories of driving data; and
calculating the driving condition of the vehicle at the second moment based on the transmission duration and the plurality of categories of driving data to obtain the second driving data.

13. The method according to claim 1, wherein the calculating, based on the transmission duration and the first driving data, second driving data for representing a driving condition of the vehicle at a second moment comprises:
obtaining specified duration, the specified duration being estimated duration required for calculating the second driving data and generating the driving image;
determining a sum of the transmission duration and the specified duration as target duration; and
calculating, based on the target duration and the first driving data, the second driving data for representing the driving condition of the vehicle at the second moment.

14. A vehicle data processing apparatus, comprising:
one or more processors; and
a memory, configured to store one or more programs, the one or more programs, when executed by the one or more processors, causing the one or more processors to perform:
obtaining transmission duration for transmitting first driving data from a vehicle to a vehicle control terminal, the first driving data representing a driving condition of the vehicle at a first moment;
calculating, based on the transmission duration and the first driving data, second driving data for representing a driving condition of the vehicle at a second moment, the second moment being later than the first moment; and
generating, based on the second driving data, a driving image representing the driving condition of the vehicle at the second moment.

15. The apparatus according to claim 14, wherein the one or more processors are further configured to perform:
presenting the driving image, so that the vehicle control terminal controls a driving status of the vehicle based on the driving image.

16. The apparatus according to claim 14, wherein the first driving data comprises a first position parameter indicating a position of the vehicle at the first moment, a first traffic travel indication parameter indicating a first traveling direction of the vehicle, and a first movement parameter indicating a motion state of the vehicle; and the calculating, based on the transmission duration and the first driving data, second driving data for representing a driving condition of the vehicle at a second moment comprises:
calculating a position of the vehicle at the second moment based on the transmission duration, the first position parameter, the first traffic travel indication parameter, and the first movement parameter, to obtain a second position parameter; and
using the second position parameter as the second driving data.

17. The apparatus according to claim 16, wherein the calculating a position of the vehicle at the second moment based on the transmission duration, the first position parameter, the first traffic travel indication parameter, and the first movement parameter comprises:
determining the first traveling direction of the vehicle based on the first traffic travel indication parameter;
calculating, based on the transmission duration and the first movement parameter, a first traveling distance of the vehicle in the first traveling direction; and
calculating the second position parameter based on the first position parameter and the first traveling distance of the vehicle in the first traveling direction.

18. The apparatus according to claim 17, wherein the first traffic travel indication parameter comprises a heading angle; and the determining a first traveling direction of the vehicle based on the first traffic travel indication parameter comprises:
analyzing the first traveling direction based on the heading angle.

19. The apparatus according to claim 17, wherein the calculating, based on the transmission duration and the first movement parameter, a first traveling distance of the vehicle in the first traveling direction comprises:
calculating, in response to that the first traveling direction is a straight direction and the first movement parameter comprises speed, a first traveling distance of the vehicle in the straight direction based on the transmission duration and the speed; and
in response to that the first traveling direction is a turning direction and the first movement parameter comprises the speed and an angular velocity,
calculating heading angle change amount based on the transmission duration and the angular velocity,
calculating a turning radius based on the speed and the angular velocity, and
calculating, based on the heading angle change amount and the turning radius, a first traveling distance of the vehicle in the turning direction.

20. A non-transitory computer-readable storage medium, having a computer program stored thereon, the computer program, when executed by at least one processor, causing the at least one processor to perform:
obtaining transmission duration for transmitting first driving data from a vehicle to a vehicle control terminal, the first driving data representing a driving condition of the vehicle at a first moment;
calculating, based on the transmission duration and the first driving data, second driving data for representing a driving condition of the vehicle at a second moment, the second moment being later than the first moment; and
generating, based on the second driving data, a driving image representing the driving condition of the vehicle at the second moment.
